(19) United States
(12) Patent Application Publication
(10) Pub. No.: US 2022/0395837 A1
(43) Pub. Date: Dec. 15, 2022

(54) THERMOCYCLER TEMPERATURE CONTROL

(71) Applicant: DeepDiveBio, Inc., San Diego, CA (US)

(72) Inventors: Tei NEWMAN-LEHMAN, San Diego, CA (US); Eric Robert YOUNG, Encinitas, CA (US); Thomas ROTH, Reno, NV (US)

(21) Appl. No.: 17/777,231

(22) PCT Filed: Nov. 16, 2020
(86) PCT No.: PCT/US2020/060794

§ 371 Date: May 16, 2022

Related U.S. Application Data
(60) Provisional application No. 62/937,109, filed on Nov. 18, 2019.

(51) Int. Cl. B01L 7/00; B01J 19/00; B01L 3/00

(52) U.S. Cl. CPC B01L 7/52; B01J 19/0046; B01L 3/50855; B01L 3/502715; B01J 2219/00722; B01L 2300/1827; B01L 2200/147; B01L 2300/046; B01J 2219/00283; B01J 2219/00317; B01J 2219/00495; B01J 2219/00011; B01J 2219/00704; B01J 2219/00716; B01J 2219/00693

(57) ABSTRACT

Provided are devices, methods, and systems for temperature control of individual containers in a thermocycler for polynucleotide synthesis. Provided herein are devices, methods, and systems comprising a circuit patch having a heating element that is placed over a reaction container on a lid of the reaction container or directly over the reaction container Provided herein are devices, methods, and systems comprising a single-piece sensor assembly for a thermistor plate assembly comprising a sensor holder having a sensor pad that is in contact with the container holder.

### CROSS-REFERENCE

This application claims the benefit of U.S. Provisional Application No. 62/937,109, filed on Nov. 18, 2019, which is incorporated by reference herein in its entirety.

### BACKGROUND

Custom polynucleotide synthesis provides a powerful tool for research in biology and medicine and for various biotechnology applications. Polynucleotide synthesis typically involves controlling the temperature of a reaction container and the reaction within the reaction container according to a temperature protocol using a thermocycler. There remains a need for reducing the time and cost required to generate the polynucleotides and enhancing the workflow involved and quality of the synthesized polynucleotide.

### SUMMARY

The devices, methods, and systems provided herein address this need, and provide advantages in polynucleotide synthesis. The devices, methods, and systems provided herein allows for asynchronous, random access to individual sample containers in a thermocycler. The devices, methods, and systems provided herein reduce time and cost and provide more accurate control of temperature of individual reaction containers. The devices, methods, and systems simplify or reduce the user input in performing the polynucleotide synthesis, which streamlines the workflow involved, saves time, and makes for a more user-friendly experience. The devices, methods, and systems facilitate and simplify the fabrication and manufacturing of components of the thermocycler, including but not limited to the reaction container lids and the thermistor plate assembly. This can reduce the time and cost in components and labor in the fabrication of the thermocycler components.

Provided herein are devices, methods, and systems comprising a circuit patch having a heating element that is placed over a reaction container. The circuit patch may be placed on a lid or a covering film of the reaction container or directly over the reaction container. The circuit patch may be fabricated as a part of a lid or the reaction container. The circuit patch provides a capability to control the temperature of the lid or the film and/or a top portion of the reaction container. The circuit patch may comprise a sensor that measures the current temperature of the lid and/or the top portion of the reaction container. The information about the current temperature may be used to verify that a target temperature from the heat provided by the heating element is achieved. This information about the current temperature may be used to adjust the heating provided by the heating element when the measured temperature is different than the target temperature. The sensor may be a thermochromic sensor that changes color with a temperature change, which can be captured on a camera. The circuit patch may comprise an identification marking, including but limited to a QR code or a bar code, that can be read by a camera. The camera may read the identification marking, identify a temperature protocol assigned to that identification marking, match the temperature protocol to the container covered by the circuit patch, and run the temperature protocol on the container. The temperature protocol may be run automatically without user input. The circuit patch may also comprise electrically conductive contacts. The electrically conductive contacts interfaces with the contacts on a printed circuit board (PCB) for a reaction container holder plate assembly when the container covered by the circuit patch is placed in to the reaction container holder. This allows the circuit patch to communicate with the PCB and the thermocycler system. The circuit patch may be flexible. A user may place the circuit patch on a lid or a sealing film or over a container prior to loading the container into the thermocycler. The sealing film may be generally rigid with areas that are pierceable and/or removable. Usually, the removable area comprises the circuit patch having a heater and a sensor. The pierceable and/or removable areas are directly over the container to allow access to the sample in the container. The circuit patch may be provided on a lid for a container to the user. Such devices, methods, and systems provided herein provide more accurate control of temperature of individual containers.

The devices, methods, and systems provided herein provide various advantages. The devices, methods, and systems may reduce the time and cost by allowing for control of the temperature of individual lids. This allows for reactions to be performed asynchronously in a portion of the reaction container holder plate assembly while another portion of the plate assembly is still being loaded with reaction containers or adjusted from an earlier run. This allows a user to run reactions in portion of the plate assembly without disturbing the reactions in other portion of the plate assembly. In contrast, the reaction would need to be completed or aborted to make any changes to the containers in the plate assembly when using typical thermocycler heating lids that cover the entire plate area. This flexibility in performing reactions in a portion of the plate assembly may allow the user to try out a number of different reactions serially or in sequence in different portions of the plate assembly. This may reduce the cost of reagents and consumable and save time by preparing loading the containers having reagents for a next set of reactions while a previous set of reactions are running. The devices, methods, and systems provided herein may improve the throughput by providing the capability to run multiple protocols with different steps in parallel or serially and using modular architecture that makes it easy to scale. The devices, methods, and systems provided herein may reduce costs where each container lid or circuit patch cover serves as its own device and has an independent functionality from another container lid or circuit patch cover. The devices, methods, and systems reduce the user input in performing the polynucleotide synthesis, which streamlines the workflow involved, saves time, and makes for a more user-friendly experience. The devices, methods, and systems provided herein may improve the quality of the products of the polynucleotide synthesis and reduce the cost and time of the polynucleotide synthesis.

Also provided herein are devices, methods, and systems comprising a sensor assembly for a thermistor plate assembly comprising a sensor holder having a sensor pad. The sensor assembly may be ring-shaped where the sensor holder may be on the inner perimeter of the ring. The sensor assembly may have two sensor holders on opposite side of the ring-shaped sensor assembly. The sensor holder may hold a thermistor and have an opening for the thermistor wires to extend out from the sensor holder to connect to the circuit board of the plate assembly. The sensor pad may be spring-loaded in order to provide a pressure to keep the sensor pad in contact with the container holder when the container holder is placed into the plate assembly. The sensor pad may provide a large surface area for efficient thermal transfer amongst a container holder, the sensor pad, the sensor holder, and the thermistor or the sensor in the sensor holder. The sensor assembly may have plate securing legs to help secure the sensor assembly to the plate assembly. The sensor assembly may be fabricated as single piece by a number of processes including but not limited to a die and roll form process and a coining process. The devices, methods, and systems facilitate and simplify the fabrication and manufacturing of the thermistor plate assembly. The devices, methods, and systems comprising the sensor assembly described herein may reduce the number of parts and steps to assemble the sensor assembly into the plate assembly. The sensor assembly may not require as high precision in the assembly and may be have greater error tolerance in assembly to have a functionally acceptable plate assembly. As such, this can reduce the time and cost in components and labor in the fabrication of the thermocycler components.

Provided herein is a circuit patch for heating a lid of a container comprising at least one of a resistive heating element, an electrically conductive printed contact, or a temperature sensing element, or a combination thereof. In some embodiments, the circuit patch is placed on a top portion of the lid. In some embodiments, the circuit patch has an adhesive surface that is placed on the top portion of the lid. In some embodiments, the circuit patch is directly molded into the lid.

Also provided herein is a heating lid for a container comprising: a lid having a top portion and a bottom portion, wherein the bottom portion is configured to close an open end of the container; and a circuit patch in contact with the lid. In some embodiments, the circuit patch comprises at least one of a heating element, an electrically conductive contact, or a temperature sensor, or a combination thereof.

Further provided herein is a sample vial for heating a sample comprising: a container having an open end; and a heating lid comprising i) a lid having a top portion and a bottom portion, wherein the bottom portion is configured to close the open end of the container, and ii) a circuit patch in contact with the lid. In some embodiments, the sample comprises a polynucleotide. In some embodiments, the sample vial is used on a thermocycler. In some embodiments, heating of the lid prevents condensation and volume loss of the sample. In some embodiments, the circuit patch comprises at least one of a heating element, an electrically conductive contact, or a temperature sensor, or a combination thereof.

Also provided herein is a system for independent thermocycling for polynucleotide synthesis comprising: a) a plurality of sample vials, wherein a sample vial comprising a container having an open end and a heating lid comprising i) a lid having a top portion and a bottom portion, wherein the bottom portion is configured to close the open end of the container, and ii) a circuit patch in contact with the lid; a vial holder; b) a control system; and c) a camera. In some embodiments, the heating element of the sample vial is independently controlled by the control system. In some embodiments, the camera comprises a visible light camera. In some embodiments, the camera comprises an infrared camera. In some embodiments, the camera is capable of capturing the plurality of sample vials in a single image. In some embodiments, the camera continually captures images of the plurality of sample vials. In some embodiments, the plurality of sample vials comprises at least 96 sample vials. In some embodiments, the vial holder comprises at least 96 openings, wherein each opening is configured to hold a sample vial. In some embodiments, a temperature of one vial holder opening is controlled independently from a temperature of another vial holder opening. In some embodiments, the sample comprises a polynucleotide. In some embodiments, the sample vial is used on a thermocycler. In some embodiments, heating of the lid prevents condensation and volume loss of the sample. In some embodiments, the circuit patch comprises at least one of a heating element, an electrically conductive contact, or a temperature sensor, or a combination thereof. In some embodiments, the heating element of the lid in the lid strip is controlled independently from a heating element of a neighboring lid by a control system.

Further provided herein is a method of independent thermocycling for polynucleotide synthesis comprising: a) loading a sample into a sample vial comprising i) a container having an open end and ii) a circuit patch in contact with the lid, wherein the circuit patch comprises a heating element, an electrically conductive contact, and a temperature sensor; b) placing the sample vial holding the sample into a container holder of a thermocycler; and c) running a thermocycling protocol on the sample vial, wherein running comprises continually reading a temperature of the lid by the temperature sensor and adjusting the temperature provided by the heating element as needed. In some embodiments, running a thermocycling protocol on the sample vial further comprises using a camera to detect an identification marking on the lid, matching the detected identification marking with a thermocycling protocol from a database in communication with the thermocycler, assigning the matched thermocycling protocol to the sample vial, and changing the temperature provided by the heating element based the matched thermocycling protocol. In some embodiments, the temperature provided by the heating element changed based on matched thermocycling protocol and the temperature of the lid read by the temperature sensor. In some embodiments, the database is in communication with the thermocycler. In some embodiments, running thermocycling protocol is performed without user input. In some embodiments, running thermocycling protocol is performed automatically after the sample vial is placed into the container holder. In some embodiments, adjusting the temperature provided by the heating element is performed by a control system without user input. In some embodiments, the sample comprises a polynucleotide. In some embodiments, heating of the lid prevents condensation and volume loss of the sample. In some embodiments, the circuit patch comprises at least one of a heating element, an electrically conductive contact, or a temperature sensor, or a combination thereof.

In some embodiments, the resistive heating element is embedded in the circuit patch. In some embodiments, the resistive heating element is an electrically conductive printed contact. In some embodiments, the resistive heating element changes the temperature of the lid. In some embodiments, the resistive heating element has a temperature range from 50° C. to 110° C. In some embodiments, the circuit patch comprises at least two electrically conductive printed contact. In some embodiments, the electrically conductive printed contact is placed near the perimeter of the lid. In some embodiments, the electrically conductive printed contact is placed on top of a hole near the perimeter of the lid. In some embodiments, the hole is configured to fit an end portion of a spring-loaded contact on a lid heating printed circuit board (PCB) of a container holder when the container is placed in the container holder and the lid closes the open end of the container. In some embodiments, the spring-loaded contact has a diameter of no more than 0.5 mm. In some embodiments, the electrically conductive printed contact comes into contact with an end portion of a spring-loaded contact on a container holder when the container is placed in the container holder and the lid closes the open end of the container. In some embodiments, the electrically conductive printed contact is spaced apart from the resistive heating element.

In some embodiments, the temperature sensing element comprises at least one of a thermistor, a thermocouple, a resistance temperature detector (RTD), or a thermochromic sticker, or a combination thereof. In some embodiments, the thermistor is a thin film thermistor. In some embodiments, the temperature sensing element is capable of detecting a temperature range from 50° C. to 110° C. In some embodiments, the thermochromic sticker is capable of detecting a temperature range from 50° C. to 110° C. In some embodiments, the thermochromic sensor is a printed layer of thermochromic ink. In some embodiments, the thermochromic sticker changes color as a temperature of the circuit patch changes. In some embodiments, the color change of the thermochromic sticker is captured by a camera. In some embodiments, the camera comprises a visible light camera. In some embodiments, the camera comprises an infrared camera.

In some embodiments, a control system uses color change to check temperature of the lid heated by the resistive heating element and makes changes to heating by the resistive heating element as needed. In some embodiments, a control system uses a reading by the temperature sensing element to control temperature of the resistive heating element. In some embodiments, a control system uses temperature sensing element to check temperature of the lid heated by the resistive heating element and makes changes to heating by the resistive heating element as needed. In some embodiments, the control system makes changes to heating by the resistive heating element without user input. In some embodiments, the temperature sensing element is placed on a top surface of the circuit patch. In some embodiments, the temperature sensing element is placed on top of the resistive heating element. In some embodiments, the temperature sensing element is offset from the resistive heating element and near a perimeter of the lid.

In some embodiments, the circuit patch or the container comprises a unique marking. In some embodiments, the unique marking comprises a QR code. In some embodiments, the unique marking comprises an RFID identifier. In some embodiments, the unique marking comprises an identification information. In some embodiments, the identification information comprises at least one of a sample information, a protocol information, or a temperature protocol information, or a combination thereof. In some embodiments, the unique marking is readable by a camera. In some embodiments, the circuit patch has a thickness of no more than 0.5 mm. In some embodiments, the circuit patch has a thickness of about 0.35 mm.

In some embodiments, the lid comprises a plastic. In some embodiments, the plastic comprises at least one of polyethylene, polypropylene, or a combination thereof. In some embodiments, the lid made by injection molding. In some embodiments, the lid is connected to another lid in a lid strip. In some embodiments, the lid strip comprises 4, 8, 12, 24, 48, 96, 128, 384, or 1536 lids. In some embodiments, the heating element of the lid in the lid strip is controlled independently from a heating element of a neighboring lid by a control system. In some embodiments, the container is connected to another container in a plurality of containers. In some embodiments, the plurality of containers comprises at least 4, 8, 12, 24, 48, 96, 128, 384, or 1536 containers. In some embodiments, the plurality of containers comprises 4, 8, 12, 24, 48, 96, 128, 384, or 1536 containers. In some embodiments, the plurality of containers is a multiwell plate. In some embodiments, the plurality of containers is consumable. In some embodiments, the circuit patch is in a layer of a plurality of circuit patches. In some embodiments, the circuit patch in the plurality of circuit patches is spaced to match the spacing of a plurality of containers. In some embodiments, the plurality of circuit patches comprises 4, 8, 12, 24, 48, 96, 128, 384, or 1536 circuit patches.

In some embodiments, the layer of the plurality of circuit patches comprises an adhesive layer. In some embodiments, the adhesive layer allows for adhesion the plurality of containers. In some embodiments, layer of the plurality of circuit patches comprises an adhesive layer, a sealing layer, and a circuit layer. In some embodiments, the adhesive layer allows for adhesion the plurality of containers. In some embodiments, the adhesive layer comprises at least one of a pressure sensitive adhesive or a thermal adhesive. In some embodiments, the sealing layer provides a barrier to water vapor. In some embodiments, the sealing layer comprises a heat-resistant polymer. In some embodiments, the flexible circuit layer comprises an adhesive layer, a heater layer, a substrate layer, and a printed layer. In some embodiments, the heater layer comprises a resistive heating element, an electrically conductive contact, and a temperature sensor. In some embodiments, the printed layer comprises a thermochromic ink patch and an identification marking. In some embodiments, the identification marking comprises a QR code. In some embodiments, the lid and the container are made from the same material. In some embodiments, the lid and container are made from different material. In some embodiments, the bottom portion of the lid seals the open end of the container. In some embodiments, the bottom portion of the lid snaps on to the open of the container.

In some embodiments, the container comprises at least one protruding latch on an outer surface of the container. In some embodiments, the container comprises a plurality of protruding latches. In some embodiments, the protruding latch latches onto a container holder to lock the container into place. In some embodiments, the protruding latch latches onto a container holder to place the electrically conductive in contact with an end portion of a spring-loaded contact on a lid heating printed circuit board (PCB) of the container holder. In some embodiments, the container comprises a magnetic or electromagnetic securing element. In some embodiments, heating of the lid prevents condensation and volume loss of the sample.

In some embodiments, the circuit patch has an opening. In some embodiments, the circuit patch opening allows for viewing into the container below when the circuit patch is placed over the container. In some embodiments, the circuit patch opening allows for imaging by the camera of the sample in the container when the circuit patch is placed over the container. In some embodiments, imaging by the camera of the sample through the circuit patch opening provides information about the sample. In some embodiments, the sample information is a concentration of a product of a reaction in the container. In some embodiments, the thermocycler stops the thermocycling protocol for the container when the concentration of the product is above a threshold concentration. In some embodiments, the sample information is a concentration of a reagent in the container. In some embodiments, the thermocycler stops the thermocycling protocol for the container when the concentration of the reagent is below a threshold concentration.

Provided herein is a sensor assembly for a sensor plate assembly, the sensor assembly comprising: a ring-shaped element having an inner perimeter, and a sensor holder having a sensor pad. In some embodiments, the sensor assembly is fabricated as a single piece. In some embodiments, the sensor assembly is fabricated by a die and roll form process. In some embodiments, the sensor assembly is fabricated by a coining process.

Further provided herein is a sensor plate assembly for thermocycling comprising: a) a plurality of sensor assemblies, a sensor assembly comprising: a ring-shaped element having an inner perimeter, and a sensor holder having a sensor pad; b) a plurality of openings for container holders; c) a plurality of openings for securing sensor assemblies; d) a plurality of holes for sensor wires; and e) a circuit board for the sensor plate assembly.

In some embodiments, the sensor holder holds a sensor in place. In some embodiments, the sensor is a thermistor. In some embodiments, the sensor holder is connected to the ring-shaped portion along the inner perimeter of the ring-shaped portion. In some embodiments, the sensor holder extends upwards from the ring-shaped portion. In some embodiments, the ring-shaped element surrounds an opening in the sensor plate assembly, wherein the opening is configured to hold a container holder. In some embodiments, the ring-shaped element has a flat bottom surface. In some embodiments, the sensor assembly comprises at least two sensor holders that are evenly spaced apart. In some embodiments, the sensor assembly comprises at least two sensor pads that are evenly spaced apart. In some embodiments, the sensor holder comprises a housing having an opening and a wall. In some embodiments, the housing comprises a tube. In some embodiments, the housing comprises a tapered tube. In some embodiments, the wall of the housing is at an angle of no more than 90 degrees relative to a centerline of the ring-shaped element. In some embodiments, the wall of the housing tilts inward toward the center of the ring-shaped element. In some embodiments, the housing holds a thermistor and the opening is configured for at least one sensor wire to extend out from the sensor holder. In some embodiments, the sensor wire connects the thermistor to the sensor plate assembly. In some embodiments, the sensor wire is soldered onto a circuit board for the sensor plate assembly. In some embodiments, the circuit board is a printed circuit board (PCB).

In some embodiments, the sensor pad extends from the housing of the sensor holder and contacts an outer surface of a container holder. In some embodiments, the sensor pad provides for a large surface area for thermal transfer between the container holder and the sensor holder, wherein the large surface area improves the efficiency and accuracy of the thermal transfer. In some embodiments, the sensor pad provides for a large surface area for thermal transfer between the container holder and the sensor holder, wherein the large surface area improves the efficiency and accuracy of the thermal transfer. In some embodiments, the sensor pad comprises a spring-loaded portion configured to contact the outer surface of the container holder. In some embodiments, the sensor pad applies pressure to the outer surface of the container holder when the container holder placed in the ring-shaped element, wherein the pressure helps to keep the sensor pad in contact with the outer surface. In some embodiments, the sensor pad comprises a material having flexibility and memory. In some embodiments, the sensor pad comprises a material having a low elastic modulus. In some embodiments, the sensor pad comprises a material having an appropriate elongation. In some embodiments, the sensor pad has a height of at least 1 mm and a length of at least 1 mm. In some embodiments, the sensor holder is connected to the ring-shaped element perpendicularly. In some embodiments, the sensor holder is connected to the ring-shaped element at an angle no more than 90 degrees relative to an inner perimeter of the ring-shaped element. In some embodiments, the sensor pad is perpendicular to the ring-shaped element. In some embodiments, the sensor pad is at an angle no more than 90 degrees relative to an inner perimeter of the ring-shaped element.

In some embodiments, the sensor assembly further comprises a support rib. In some embodiments, the support rib is connected to the ring-shaped portion along the inner perimeter of the ring-shaped portion. In some embodiments, the support rib extends upwards from the ring-shaped portion. In some embodiments, the support rib extends from the ring-shaped portion in same direction as the sensor holder. In some embodiments, the support rib provides anti-distortion support. In some embodiments, the support rib provides a spring-loaded support to position a container holder. In some embodiments, the sensor assembly comprises at least two support rib that are evenly spaced apart.

In some embodiments, the sensor assembly comprises a material with high thermal conductivity. In some embodiments, the material comprises at least one of copper, tin, or phosphor bronze, or a combination thereof. In some embodiments, the material comprises a copper alloy. In some embodiments, the material comprises copper beryllium. In some embodiments, the material has thermal conductivity greater than 100 W/m*K. In some embodiments, the material has thermal conductivity greater than 200 W/m*K. In some embodiments, the sensor assembly further comprises at least two plate securing elements connected to the ring-shaped element. In some embodiments, the plate securing elements connect to an outer perimeter of the ring-shaped element. In some embodiments, the plate securing elements extend downward from the ring-shaped element. In some embodiments, the plate securing elements extend from the ring-shaped element in opposite direction as the sensor holder. In some embodiments, the plate securing elements are connected to the ring-shaped element at about 90 degrees relative to the ring-shaped element. In some embodiments, the plate securing elements have a width of at least 1 mm and a length of at least 2 mm. In some embodiments, the plate securing elements fit into securing holes in the sensor plate assembly to secure the sensor assembly onto the sensor plate assembly. In some embodiments, the plate securing elements are sized to have a smaller width than the securing holes. In some embodiments, design of the sensor assembly reduces assembly error in placing the sensor assembly on the sensor plate assembly.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an example of thermistor plate assembly comprising a plurality of containers covered by circuit patches, a camera, a circuit patch heating printed circuit board (PCB), a spacer block, and the thermocycler core.

FIG. 2 shows an example of a container and a circuit patch for the lid of the container.

FIG. 3 shows an example of a circuit patch heating PCB having spring-loaded contacts to contact the circuit patch.

FIG. 4 shows an example of a circuit patch heating PCB having spring-loaded contacts that are contacting the circuit patch.

FIG. 5 shows an example of a circuit patch in a top view and a side view.

FIG. 6 shows an example of a circuit patch in a top view.

FIG. 7 shows an example of a circuit patch with an opening to view into the container in a top view.

FIG. 8A shows an example of a sensor assembly in an angled top view.

FIG. 8B shows an example of a sensor assembly in a top view.

FIG. 9 shows an example of a sensor assembly in a bottom view.

FIG. 10 shows an example of a sensor assembly with a thermistor in the sensor holder in an angled top view.

FIG. 11 shows a close up view of an example of a sensor assembly assembled on a plate assembly.

FIG. 12 shows an example of a plurality of sensor assemblies assembled on a plate assembly with a plurality of container holders and a plurality of containers.

FIG. 13 shows a close up view of an example of a sensor assembly on a plate assembly.

FIG. 14 shows a close up view of an example of a sensor assembly on a plate assembly.

FIG. 15 shows an example of a sensor assembly in a top view.

FIG. 16 shows an example of a sensor assembly in a side view.

FIG. 17 shows an example of a sensor assembly in a bottom view.

FIG. 18 shows an example of a sensor assembly in a side view.

FIG. 19 shows an example of a sensor assembly in a side view.

FIG. 20 shows an example of a sensor assembly assembled with a container holder.

FIG. 21 shows an example of a sensor assembly cutout design.

FIG. 22 shows an example of a sensor assembly in an angled view, top view, and side views.

FIG. 23 shows an example of a plurality of sensor assemblies assembled on a plate assembly with a plurality of container holders in a top view, a bottom view, and a close up top view.

FIG. 24 shows an example of a design layout for a PCB plate having a plurality of holes for the sensor assembly and sensor wires.

FIG. 25 shows an example of a design layout for a PCB plate having a plurality of holes for the sensor assembly and sensor wires.

FIG. 26 shows an example of a top view of a mat having a plurality of circuit patches for a plate covering and a close up top view of a circuit patch.

FIG. 27 shows an example of a top view of a plate having a plurality of reaction containers.

FIG. 28 shows an example of a side view of a plate having a plurality of reaction containers.

FIG. 29 shows an example of a plate covered with a mat having a plurality of circuit patches.

FIG. 30 shows an example of a top view of a plate covered with a mat having a plurality of circuit patches.

### DETAILED DESCRIPTION

Described herein are devices, methods, and systems for improving polynucleotide synthesis. The devices, methods, and systems provided herein allows for asynchronous, random access to individual sample containers in a thermocycler. Provided herein are devices, methods, and systems comprising a circuit patch having a heating element that is placed over a reaction container. The circuit patch may be placed on a lid of the reaction container, or a covering film for the reaction container, or directly over the reaction container. The circuit patch may be directly molded into the lid or the reaction container. The circuit patch provides a capability to control the temperature of the lid or film and/or a top portion of the reaction container, where the control is independent for another circuit patch for another container in the thermocycler. The circuit patch described herein may be used with a thermocycler having a capability to control a temperature setting of an individual reaction container independently from a temperature setting of another individual reaction container. The circuit patch may comprise a sensor that measures the current temperature of the lid and/or the top portion of the reaction container. The information about the current temperature may be used to verify that a target temperature from the heat provided by the heating element is achieved. This information about the current temperature may be used to adjust the heating provided by the heating element when the measured temperature is different than the target temperature. The sensor may be a thermochromic ink patch that changes color with a temperature change, which can be captured on a camera. The sensor may be a blackbody that can be imaged using an infrared (IR) sensitive camera to capture temperature changes. The circuit patch may have an identification marking, including but limited to a QR code or a bar code that can be read by a camera or a RFID tag that can be read by a RFID reader. The camera may read the identification marking, identify a temperature protocol assigned to that identification marking, match the temperature protocol to the container covered by the circuit patch, and run the temperature protocol on the container. The temperature protocol may be run automatically without user input. The circuit patch may have electrically conductive contacts. These electrically conductive contacts interfaces with the contacts on a printed circuit board (PCB) for a reaction container holder plate assembly when the container covered by the circuit patch is placed in to the reaction container holder. This allows the circuit patch to communicate with the PCB and the thermocycler system. The circuit patch may be flexible. A user may place the circuit patch on a lid or over a container prior to loading the container into the thermocycler. The sealing film may be generally rigid with areas that are pierceable and/or removable. Usually, the removable area comprises the circuit patch having a heater and a sensor. The pierceable and/or removable areas are directly over the container to allow access to the sample in the container. The circuit patch may be provided on a lid for a container to the user. Such devices, methods, and systems provided herein provide more accurate control of temperature of individual containers.

The devices, methods, and systems provided herein provide various advantages. The devices, methods, and systems may reduce the time and cost by allowing for control of the temperature of individual lids. This allows for reactions to be performed asynchronously in a portion of the reaction container holder plate assembly while another portion of the plate assembly is still being loaded with reaction containers or adjusted from an earlier run. This allows a user to run reactions in portion of the plate assembly without disturbing the reactions in other portion of the plate assembly. In contrast, the reaction would need to be completed or aborted to make any changes to the containers in the plate assembly when using typical thermocycler heating lids that cover the entire plate area. This flexibility in performing reactions in a portion of the plate assembly may allow the user to try out a number of different reactions serially or in sequence in different portions of the plate assembly. This may reduce the cost of reagents and consumable and save time by preparing loading the containers having reagents for a next set of reactions while a previous set of reactions are running. The devices, methods, and systems provided herein may improve the throughput by providing the capability to run multiple protocols with different steps in parallel or serially and using modular architecture that makes it easy to scale. The devices, methods, and systems provided herein may reduce costs where each container lid or circuit patch cover serves as its own device and has an independent functionality from another container lid or circuit patch cover. The devices, methods, and systems reduce the user input in performing the polynucleotide synthesis, which streamlines the workflow involved, saves time, and makes for a more user-friendly experience. The devices, methods, and systems provided herein may improve the quality of the products of the polynucleotide synthesis and reduce the cost and time of the polynucleotide synthesis.

Also provided herein are devices, methods, and systems comprising a sensor assembly for a thermistor plate assembly comprising a sensor holder having a sensor pad. The sensor assembly described herein may be used with a thermocycler having a capability to control a temperature setting of an individual reaction container independently from a temperature setting of another individual reaction container. As such, the sensor assembly may allow for accurate and instantaneous detection temperature of individual container in the system. The sensor assembly may be ring-shaped where the sensor holder may be on the inner perimeter of the ring. The sensor assembly may have two sensor holders on opposite side of the ring-shaped sensor assembly. The sensor holder may hold a thermistor and have an opening for the thermistor wires to extend out from the sensor holder to connect to the circuit board of the plate assembly. The sensor pad may be spring-loaded in order to provide a pressure to keep the sensor pad in contact with the container holder when the container holder is placed into the plate assembly. The sensor pad may provide a large surface area for efficient thermal transfer amongst a container holder, the sensor pad, the sensor holder, and the thermistor or the sensor in the sensor holder. The sensor assembly may have plate securing legs to help secure the sensor assembly to the plate assembly. The sensor assembly may be fabricated as single piece by a number of processes including but not limited to a die and roll form process and a coining process. The devices, methods, and systems facilitate and simplify the fabrication and manufacturing of the thermistor plate assembly. The devices, methods, and systems comprising the sensor assembly described herein may reduce the number of parts and steps to assemble the sensor assembly into the plate assembly. The sensor assembly may not require as high precision in the assembly and may be have greater error tolerance in assembly to have a functionally acceptable plate assembly. As such, this can reduce the time and cost in components and labor in the fabrication of the thermocycler components.

The devices, methods, and systems provided herein reduce time and cost and provide more accurate control of temperature of individual reaction containers. The devices, methods, and systems simplify or reduce the user input in performing the polynucleotide synthesis, which streamlines the workflow involved, saves time, and makes for a more user-friendly experience. The devices, methods, and systems facilitate and simplify the fabrication and manufacturing of components of the thermocycler, including but not limited to the reaction container lids and the thermistor plate assembly. This can reduce the time and cost in components and labor in the fabrication of the thermocycler components.

Provided herein are circuit patches for heating a lid of a container comprising at least one of a resistive heating element, an electrically conductive printed contact, or a temperature sensing element, or a combination thereof. Also provided herein are heating lids for a container comprising: a lid having a top portion and a bottom portion, wherein the bottom portion is configured to close an open end of the container; and a circuit patch in contact with the lid. Further provided herein are sample vials for heating a sample comprising: a container having an open end; and a heating lid comprising i) a lid having a top portion and a bottom portion, wherein the bottom portion is configured to close the open end of the container, and ii) a circuit patch in contact with the lid. Also provided herein are systems for independent thermocycling for polynucleotide synthesis comprising: a) a plurality of sample vials, wherein a sample vial comprising a container having an open end and a heating lid comprising i) a lid having a top portion and a bottom portion, wherein the bottom portion is configured to close the open end of the container, and ii) a circuit patch in contact with the lid; a vial holder; b) a control system; and c) a camera. Provided herein are methods of independent thermocycling for polynucleotide synthesis comprising: loading a sample into a sample vial comprising i) a container having an open end and ii) a circuit patch in contact with the lid, wherein the circuit patch comprises a heating element, an electrically conductive contact, and a temperature sensor; placing the sample vial holding the sample into a container holder of a thermocycler; and running a thermocycling protocol on the sample vial, wherein running comprises continually reading a temperature of the lid by the temperature sensor and adjusting the temperature provided by the heating element as needed.

Further provided herein are sensor assemblies for a sensor plate assembly, the sensor assembly comprising: a ring-shaped element having an inner perimeter, and a sensor holder having a sensor pad. Provided herein are sensor plate assemblies for thermocycling comprising: a) a plurality of sensor assemblies, a sensor assembly comprising: a ring-shaped element having an inner perimeter, and a sensor holder having a sensor pad; b) a plurality of openings for container holders; c) a plurality of openings for securing sensor assemblies; d) a plurality of holes for sensor wires; and e) a circuit board for the sensor plate assembly.

### Circuit Patch

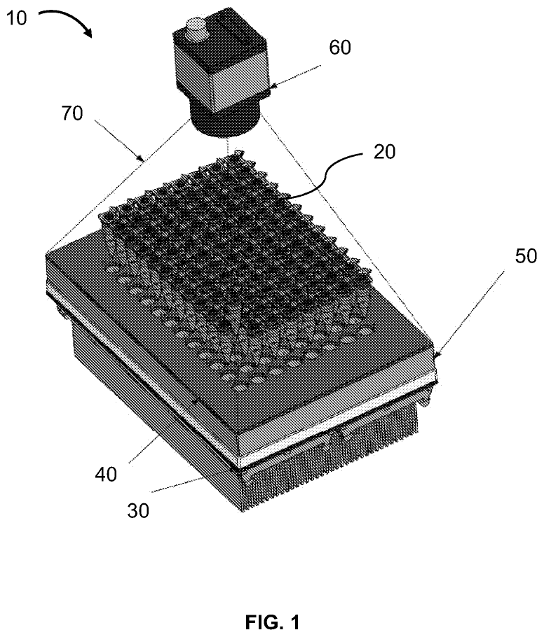

The devices, methods, and systems described herein may be a part of a thermistor plate assembly for a thermocycling device. FIG. 1 shows an example of thermistor plate assembly 10 comprising thermocycler core 30, a circuit patch heating printed circuit board (PCB) 40, a spacer block 50, and a camera 60 with a field of view 70 of the entire plate area, where a plurality of containers covered by circuit patches 20 has been placed into.

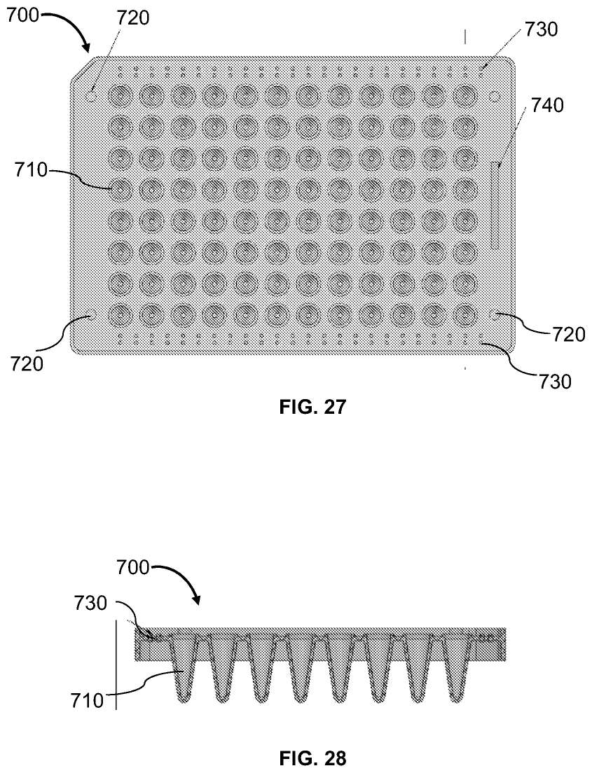

Often, a circuit patch is placed over on top of an individual container that holds a sample for thermocycling. The circuit patch can provide heat to the top portion of the individual container to reduce the condensation of the sample and volume loss of the sample. The circuit patch for one container can be controlled individually and separately from any of circuit patches placed over the other containers in the thermocycler. In some embodiments, the resistive heating element is controlled independently from a heating element of a neighboring lid by a control system. Often, the container may be a consumable product that is discarded after a single use. In some embodiments, the container is a single container or vial. In some embodiments, the container is in a strip of at least 4, 8, 12, 16, or 24 containers. In some embodiments, the container is a part of a multi-well plate. In some embodiment, the container is a part of a multi-well plate comprising at least 96, 384, or 1536 wells. In some embodiments, the container is a part of a multi-well plate made to SBS standards. In some embodiments, the container is a part of a multi-well plate, having specifications for use with laboratory automation. An example of the multi-well plate is shown in FIGS. 27 and 28.

Often, the circuit patch is placed over the opening of the container. In some embodiments, the circuit patch is placed on top of a lid for the container. In some embodiments, the circuit patch is placed on top of a film covering an opening of the container. In some embodiments, the circuit patch is a top lamination of a plate covering film, also referred to as a plate seal. In some embodiments, the circuit patch is placed directly over the opening of the container. Sometimes, the circuit patch is placed on top of a lid for the container. In some embodiments, the lid is flexibly attached to the body of the container. In some embodiments, the sealing film is generally rigid and has areas that are pierceable and/or removable. Usually, the removable area comprises the circuit patch having a heater and a sensor. In some embodiments, the removable area is assembled into the sealing film when provided to the user. In some embodiments, the user places the removable circuit patch on to the sealing film. The pierceable and/or removable areas are directly over the container to allow access to the sample in the container. In some embodiments, the circuit patch may be fabricated as a part of a lid or the reaction container. In some embodiments, the circuit patch is directedly molded into the lid or the reaction container. In some embodiments, the circuit patch is molded into the lid or the reaction container by overmolding of the circuit patch by the material for the lid or the container. In some embodiments, the lid is separate from the body of the container. In some embodiments, the lid is in a strip of at least 2 lids. In some embodiments, the lid is in a strip of at least 4, 8, 12, 16, or 24 lids. In some embodiments, the lid is in a strip of at least 2 lids.

In some cases, the circuit patch has an adhesive surface. In some cases, the adhesive surface comprises a pressure sensitive or a thermal adhesive. Sometimes, the adhesive helps to keep the circuit patch on the lid, the covering film, or over the container. In some cases, the circuit patch is attached to the lid by ultrasonic bonding or friction welding. The adhesive on the patch may be covered by a protective film that is removed before placing the patch over the container. In some embodiments, the circuit patch provided to a user already affixed to the lid or the covering film. In some cases, the user places the lid having the circuit patch over the opening of the container to seal the container after the container is filled with a sample. In some cases, the circuit patch is provided to the user for the user to place the patch on the lid, the covering film, or over the container. In some cases, the circuit patch may be placed over the container by the user after the container is filled with a sample. In some cases where the user places the circuit patch over the container, the circuit patch may be placed directly over the opening of the container, a covering film, or a lid for the container.

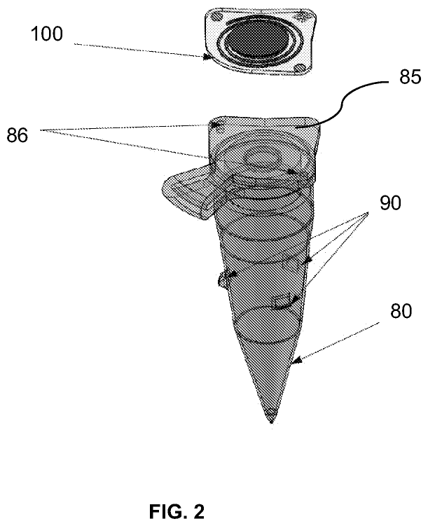

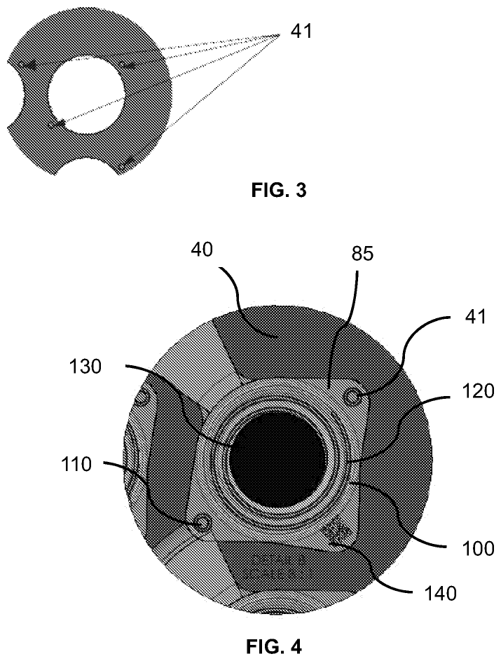

FIG. 2 shows an example of a container 80 and a circuit patch 100 for the lid 85 of the container. The container may have one or more latches 90 on the outer surface of the container to help the container stay in place once placed into the container holder. The container may have holes 86 for spring-loaded contacts from the printed circuit board to pass through to contact the printed contact of the circuit patch 100. FIG. 3 shows an example of a circuit patch heating PCB having such spring-loaded contacts 41 to contact the circuit patch. The spring-loaded contacts are also referred to as pogo pins.

Described herein are circuit patches comprising at least one of a resistive heating element, an electrically conductive printed contact, or a temperature sensing element, or a combination thereof. In some embodiments, at least one of a resistive heating element, an electrically conductive printed contact, or a temperature sensing element is embedded in the circuit patch. In some embodiments, the circuit patch comprises one or more layers. In some embodiments, the circuit patch comprises an adhesive layer as an outer layer. In some embodiments, the circuit patch has at least one of an adhesive layer, a heater layer, a substrate layer, or a printer layer, or a combination thereof. In some embodiments, the circuit patch comprises an adhesive layer, a heater layer, a substrate layer, and a printer layer. In some embodiments, the heater layer has at least one of an internal heater, an electrical contact, or a temperature sensor, or a combination thereof. In some embodiments, the internal heater is a resistive heating element. In some embodiments, the temperature sensor is a thermochromic patch that changes color with a change in temperature. In some embodiments, the electrical contact is printed on the layer. In some embodiments, the electrical contact is designed to interface with an electrical contact on the lid heating PCB when the container having the circuit patch with the electrical contact is placed on the container holder. In some embodiments, the substrate layer has a protective layer to keep the components of the heater layer in place and separated from the other layers. In some embodiments, the substrate layer provides barrier to water vapor. In some embodiments, the substrate layer is a heat resistant polymer. In some embodiments, the printed layer has at least one of a thermochromic ink patch, or an identification marking, or a combination thereof. In some embodiments, the identification marking is a QR code. In some embodiments, the identification marking is a bar code. In some embodiments, the identification marking is a RFID tag. In some embodiments, the thermochromic ink patch in the printed layer serves as a temperature sensor.

Sometimes, the circuit patch may be a top lamination of a plate covering film. In some cases, the plate covering film comprises an adhesive layer, a sealing layer, and a circuit patch. The adhesive layer provides for adhesion to the containers, which includes but is not limited to microtiter plates. In some cases, adhesive layer comprises a pressure sensitive, or a thermal adhesive, or a combination thereof. In some cases, the sealing layer provides barrier to water vapor. In some embodiments, the sealing layer is a heat resistant polymer.

In some embodiments, the circuit patch has a thickness of no more than 1, 0.9, 0.8, 0.7, 0.6, 0.5, 0.45, 0.4, 0.35, 0.3, 0.25, 0.2, 0.15. 0.1 mm. In some embodiments, the circuit patch has a thickness of no more than 0.5 mm. In some embodiments, the circuit patch has a thickness of about 1, 0.9, 0.8, 0.7, 0.6, 0.5, 0.45, 0.4, 0.35, 0.3, 0.25, 0.2, 0.15. 0.1 mm. In some embodiments, the circuit patch has a thickness of about 0.35 mm.

FIG. 4 shows an example of a circuit patch heating PCB 40 having spring-loaded contacts 41 that are contacting the circuit patch 100. The circuit patch 100 is placed on top of a lid 85 for a container and comprises multiple printed contacts 110, a resistive heating element 120 in a circular coil shape, a temperature sensor 130 that is a thermochromic patch, and an identification marker 140 in the form of a QR code near the perimeter of the patch.

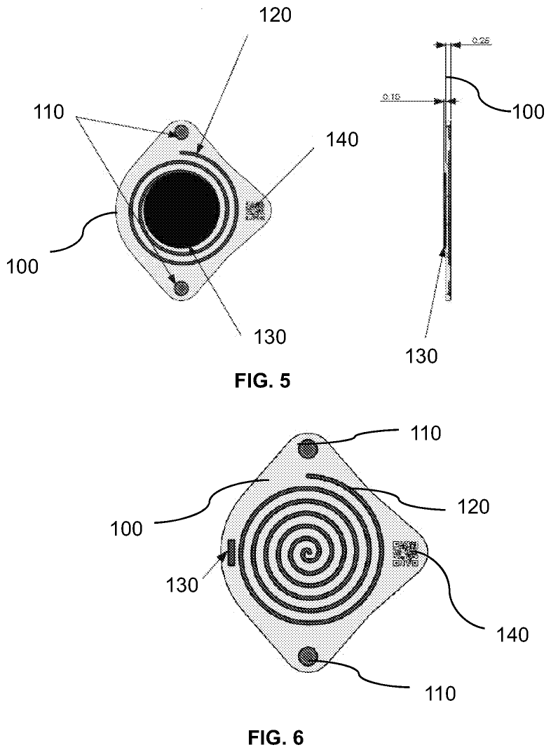

FIG. 5 shows an example of a circuit patch 100 in a top view and a side view. In some embodiments, the circuit patch 100 has multiple printed contacts 110, a resistive heating element 120 in a circular coil shape, a temperature sensor 130 in the center, and an identification marker 140 in the form of a QR code. In some embodiments, the circuit patch has a thickness of 0.25 mm. In some embodiments, the thermochromic patch has a thickness of 0.1 mm. In some cases, the temperature sensor is a blackbody for use with an IR camera for temperature detection. In some cases, the temperature sensor is a thermochromic patch.

FIG. 6 shows an example of a circuit patch in a top view. In some embodiments, the circuit patch 100 has multiple printed contacts 110, a resistive heating element 120 in a circular coil shape, a temperature sensor 130 that is a thin-film thermistor near the perimeter of the patch, and an identification marker 140 in the form of a QR code near the perimeter of the patch.

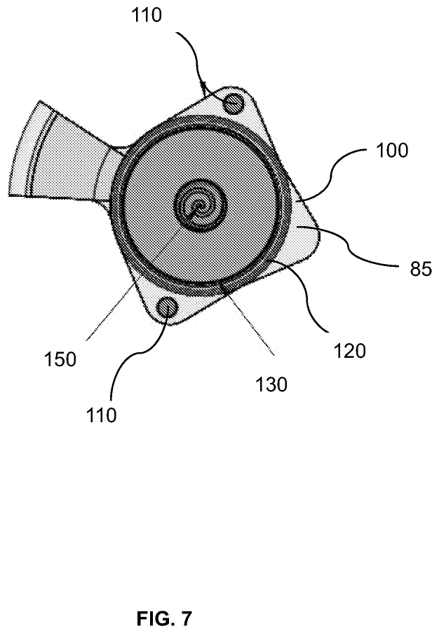

FIG. 7 shows an example of a circuit patch with an opening to view into the container in a top view. The circuit patch 100 is placed on top of a lid 85 for a container. The circuit patch 100 may have multiple printed contacts 110, a resistive heating element 120 in a circular coil shape, and a temperature sensor 130 in the center that has an opening 150. The opening 150 in the temperature sensor 130 allows for visualization of the contents inside the container, which may include the sample or an indicator for synthesis and amount of the product. The opening 150 in the temperature sensor 130 allows for visualization of the contents inside the container in situ, without having to transfer the sample to a new machine or a new container to assess its contents. The in situ visualization can be performed by the camera used to visualize the identification marker (e.g. QR code, RFID tag) or the temperature sensor that is a thermochromic ink patch. This allows for in situ visualization of the contents of the container by using the components already in use in the thermocycler and without needing additional components. In some instances, the camera can detect the concentration of the sample. In some instances, the camera-detected sample concentration is above or below a set threshold concentration, and instrument then shuts off the protocol when it reaches above or below the set threshold concentration.

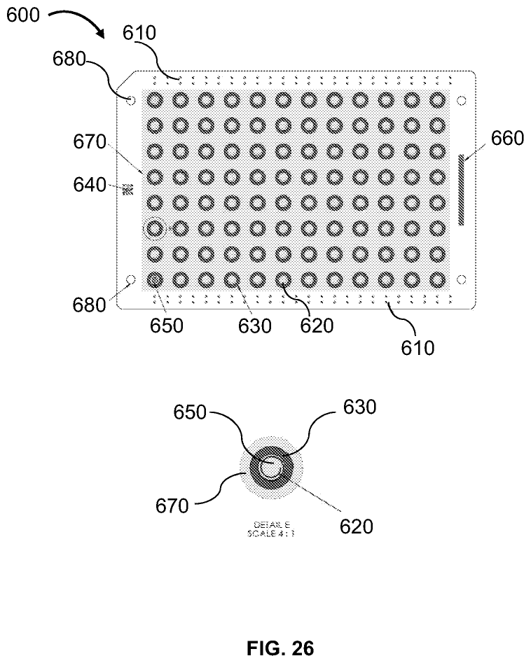

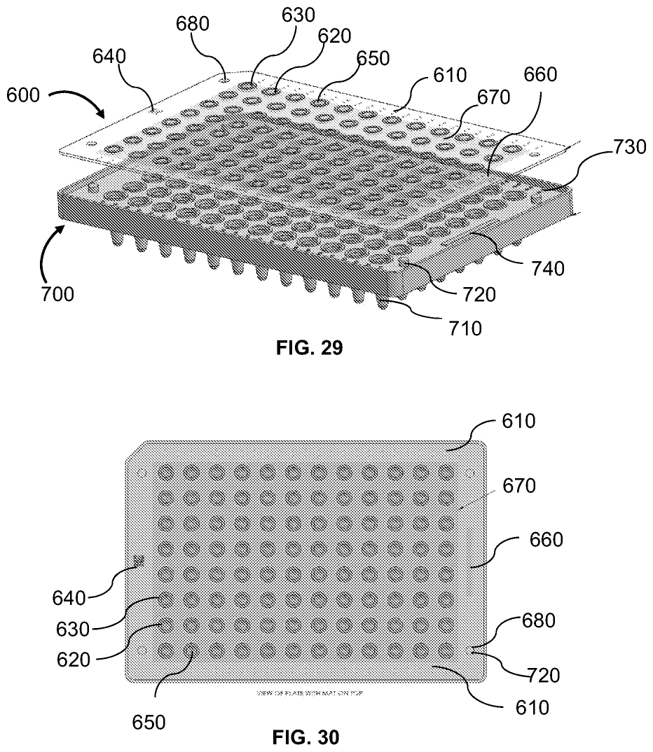

Sometimes the circuit patch covers a container in a multi-container plate. In some cases, the circuit patch is an integrated part of a mat or a plate covering film. In some cases, a user places a sheet having a plurality of circuit patches on to mat or a plate covering film. FIG. 26 shows an example of a top view of a plate covering film having a plurality of circuit patches for a plate covering and a close up top view of a circuit patch. The plate covering film 600 may have a plurality of circuit patches 605, a plurality of printed contacts 610 that are connected to the circuit patches, an identification marker 640, seen here as a QR code, a ground contact 660, and alignment holes 680. The circuit patches are attached to the plate covering film by an adhesive 670, which may be heat or pressure sensitive adhesive. Each of the circuit patch 605 has a heating element 620 and a sensor 630, which may be a thermochromic patch or a temperature sensing patch. The circuit patch may also have an opening 650 to allow view of the sample in the container 710 below the plate covering film 600. In some cases, at least one printed contact 610 is connected to each of the circuit patches 605. In some cases, the plate covering film 600 has as many printed contacts 610 as the circuit patches 605. FIGS. 27 and 28 show examples of a top view and a side view of a plate having a plurality of reaction containers. FIGS. 29 and 30 show examples of a plate covered with a mat having a plurality of circuit patches. The plate 700 has a plurality of containers 710, alignment pins 730, a plurality of heater contacts 730, and a grounding pad contact 740. The alignment holes 680 are used to line up the plate covering film 600 to the plate 700 and are designed to fit into the alignment pins 720 on the plate. The heater contacts 730 are in direct contact with the printed contacts 610 of covering film with circuit patches when the covering film seals the plate and the plate and the covering film with circuit patches are in alignment.

In some embodiments, the mat or a plate covering film having a plurality of circuit patches is aligned and placed over the plate for use in the thermocycler. The mat is placed over plate and aligned to the alignment pins on the plate. The mat is pressed along the edge of the openings of the containers to seal the openings of the containers of the plate. After the plate and the mat are placed in a thermocycling instrument, the identification marking on the mat is read by the instrument, and the corresponding thermocycling protocol is loaded into the instrument. The thermocycling protocol is run by the instrument, and a camera in the instrument continually measures the temperature of thermal sensor on the mat during the run of the thermocycling protocol. The user can remove the sample at any time. The user can use a pipette to pierce the mat and collect the sample in the container of interest.

Often, the resistive heating element generates heat by joule heating, also referred to as resistive heating or ohmic heating. In some embodiments, the resistive heating element changes the temperature of the upper portion of the container. In some embodiments, the resistive heating element changes the temperature of the lid of the container or the covering film of the container. In some embodiments, the resistive heating element has a temperature range from 30° C. to 140° C. In some embodiments, the resistive heating element has a temperature range from 40° C. to 130° C. In some embodiments, the resistive heating element has a temperature range from 50° C. to 110° C. In some embodiments, the resistive heating element has a temperature range from 60° C. to 110° C. In some embodiments, the resistive heating element has a temperature range from 50° C. to 100° C. In some embodiments, the resistive heating element can heat to at least 30° C., 40° C., 50° C., 60° C., 70° C., 80° C., 90° C., 100° C., 110° C., or 120° C. In some embodiments, the resistive heating element can heat to no more than 50° C., 60° C., 70° C., 80° C., 90° C., 100° C., 110° C., 120° C., 130° C., 140° C., or 150° C.

In some embodiments, the resistive heating element is a coil. In some embodiments, the resistive heating element forms a coiled circle on the circuit patch. In some embodiments, the resistive heating element is screen printed onto a substrate. In some embodiments, the resistive heating element comprises at least one of metal, or ceramics, or a combination thereof. In some embodiments, the metal for the resistive heating element comprises at least one of silver, nickel, molybdenum, or tungsten. In some embodiments, the metal for the resistive heating element comprises a metallic nanoparticle in a solvent. In some embodiments, the metallic nanoparticle comprises silver. some embodiment, the ceramics for the resistive heating element comprises at least one of graphite or silicon carbide. In some embodiment, the ceramic-metals for the resistive heating element comprises cermet or molybdenum disilicide. In some embodiments, the resistive heating element is an electrically conductive printed contact. In some embodiments, the resistive heating element comprises an inductive heating. In some embodiments, the inductive heating comprises a coil of embedded wire that act as a heater when exposed to an electromagnetic field. In some embodiments, the electromagnetic field is used to power the RFID antenna to generate a signal that could read the RFID identifier tag and the embedded temperature data. In some embodiments, the use of inductive heating elements mitigates the need for the electrically printed conductive contacts and/or the spring-loaded contacts in the PCB that are commonly used for resistive heating elements.

Sometimes, the circuit patch has an electrically conductive contact. In some embodiments, the circuit patch has at least 2, 3, 4, 5, 6, 7, 8, 9, or 10 electrically conductive contacts. In some embodiments, the circuit patch has two electrically conductive contacts. In some embodiments, the circuit patch has four electrically conductive contacts. In some embodiments, the circuit patch uses two electrically conductive contacts for power and at least two electrically conductive contacts for transmitting signal to and from the thermocycler. In some embodiments, the electrically conductive contacts are placed radially evenly apart on the patch. In some embodiments, the electrically conductive contacts are placed apart and on the same side of the patch. In some embodiments, the electrically conductive contacts are electrically conductive printed contacts. In some embodiments, the electrically conductive contacts are printed onto the patch. In some embodiments, the electrically conductive contact is placed near the perimeter of the patch. In some embodiments, the electrically conductive contact is placed near the perimeter of the lid for the container. In some embodiments, the electrically conductive contact is placed on top of a hole near the perimeter of the lid. In some embodiments, the hole near the perimeter of the lid allows for a spring-loaded contact from the lid heating printed circuit board (PCB) to pass through and contact the electrically conductive contact on the patch when the container is placed in the container holder and the patch is on top of the container. In some embodiments, the electrically conductive contact has a diameter of no more than 0.1, 0.2, 0.3, 0.4, 0.5, 0.6, 0.7, 0.8, 0.9, or 1.0 mm. In some embodiments, the electrically conductive contact has a diameter of no more than 0.5 mm. In some embodiments, the spring-loaded contact has a diameter of no more than 0.1, 0.2, 0.3, 0.4, 0.5, 0.6, 0.7, 0.8, 0.9, or 1.0 mm. In some embodiments, the spring-loaded contact has a diameter of no more than 0.5 mm. In some embodiments, the electrically conductive contact is spaced apart from the resistive heating element. In some embodiments, the electrically conductive contact does not overlap with the resistive heating element.

In some instances, the temperature sensor comprises at least one of a thermistor, a thermocouple, a resistance temperature detector (RTD), or a thermochromic sticker, or a combination thereof. In some instances, the temperature sensor is a thin film thermistor. In some instances, the temperature sensor is a thermochromic sticker. In some embodiments, the temperature sensor is a blackbody surface compatible for imaging with an IR camera. In some instances, the thermochromic sticker changes color as a temperature of the circuit patch changes. In some instances, the temperature sensor can detect a temperature range from 30° C. to 140° C. In some instances, the temperature sensor can detect a temperature range from 40° C. to 130° C. In some instances, the temperature sensor can detect a temperature range from 50° C. to 110° C. In some instances, the temperature sensor can detect a temperature range from 60° C. to 110° C. In some instances, the temperature sensor can detect a temperature range from 50° C. to 100° C. In some instances, the temperature sensor can detect a temperature of at least 30° C., 40° C., 50° C., 60° C., 70° C., 80° C., 90° C., 100° C., 110° C., or 120° C. In some instances, the temperature sensor can detect a temperature of no more than 70° C., 80° C., 90° C., 100° C., 110° C., 120° C., 130° C., 140° C., or 150° C.

The temperature sensor often may be a thermochromic sticker, also referred herein as a thermochromic patch or thermochromic ink patch. In some cases, the thermochromic sticker changes color as a temperature of the circuit patch changes. In some cases, color change of the thermochromic sticker is captured by a camera. In some cases, the camera is a visible light camera. In some cases, the visible light camera captures the color change on the thermochromic sticker as it changes color in response to a temperature change of the patch. In some cases, the camera is an infrared camera. In some cases, the infrared (IR) camera captures the temperature of the patch. In some embodiments, the thermocycler has a visible light camera and an infrared camera. In some cases, the control system for the thermocycler checks the temperature of at least one of the patch, the lid, the covering film, or the upper portion of the container heated by the resistive heating element. The temperature may be indicated by a color change on the thermochromic sticker that is read by the visible light camera or by detection by the infrared camera. In some cases, the camera continually captures images of the circuit patch to provide instantaneous information about the temperature of the patch and/or the upper portion of the container. When thermocycler has a visible light camera and an infrared camera, the temperature readings from the thermochromic sticker by the visible light camera and by the IR camera can be compared to provide additional check of the temperature reading of the patch and the upper portion of the container. In some cases, the control system for the thermocycler can make changes to heating by the resistive heating element as needed based on the temperature information provided by the camera. In some cases, the control system uses a reading by the temperature sensor to control temperature of the resistive heating element. In some cases, the control system uses temperature sensor to check temperature of the patch, the lid, or the covering film and makes changes to heating by the resistive heating element as needed. In some cases, the control system makes changes to heating by the resistive heating element without user input. In some cases, the temperature sensor is placed on a top surface of the circuit patch. In some cases, the temperature sensor is placed on top of the resistive heating element. In some cases, the temperature sensor is offset from the resistive heating element and near a perimeter of the patch.

In some embodiments, the circuit patch has a unique identification marking. In some embodiments, the unique marking provides an identifier of the sample in the container. In some embodiments, the unique marking is an optical marking. In some embodiments, the unique optical marking is a QR code. In some embodiments, the circuit patch has a unique marking that is an embedded RFID. In some embodiments, the embedded RFID is readable by a RFID reader. In some embodiments, the unique marking has an identification information. In some embodiments, the identification information comprises at least one of a sample information, a protocol information, or a temperature protocol information, or a combination thereof. In some embodiments, the unique marking is associated with a thermocycling protocol. In some embodiments, the thermocycling protocol associated with the unique marking is a temperature protocol. In some embodiments, the unique optical marking is readable by a camera. In some embodiments, the unique optical marking can be read by a camera or a scanner when the container having the patch is placed into a container holder in the thermocycler plate assembly. The scanned information from the camera or the scanner or the RFID reader can be communicated to the thermocycler, resulting in the thermocycler assigning and performing the temperature protocol associated with the unique marking to the container holder location that the patch and the container are placed. In some embodiments, the temperature protocol comprises a time-dependent temperature setting having a sequence of temperatures and temperature ramps over time, where each temperatures and temperature ramps are set for predetermined time frames.

The container can have a lid to cover its opening and seal the container. In some cases, the container holds the sample and is also referred to as a vial, a tube, or a well. In some cases, the container holds the sample comprising a polynucleotide and reagents that is run on the thermocycler for polynucleotide synthesis. In some cases, the lid comprises a plastic. In some cases, the plastic comprises at least one of polyethylene, polypropylene, or a combination thereof. In some cases, the lid is made by injection molding. In some cases, the lid and the container are made from the same material. In some cases, the lid and container are made from different material. In some cases, the bottom portion of the lid seals the open end of the container. In some cases, the bottom portion of the lid snaps on to the open of the container. In some cases, the lid is flexibly attached to the body of the container. In some cases, the lid is separate from the body of the container. In some cases, the lid is connected to another lid in a lid strip and the container is connected to another container in a container strip. In some cases, the lid is in a strip of at least 2 lids. In some cases, the lid is in a strip of at least 4, 8, 12, 16, or 24 lids. In some cases, the lid strip comprises 4, 8, 12, 16, or 24 lids. In some cases, the lid is in a strip of at least 2 lids.

In some cases, the container comprises at least one securing element on an outer surface of the container. In some cases, the securing element helps to secure the container to the container holder. In some cases, the securing element is a protruding latch. In some cases, the protruding latch latches onto a container holder to lock the container into place. In some cases, the securing element is a magnetic securing element. In some cases, the magnetic securing element is a permanent magnet. In some cases, the securing element is an electromagnetic securing element. In some cases, the electromagnetic securing element is an electromagnet or a solenoid. In some cases, the container comprises a plurality of securing elements. In some cases, the securing elements secures a container into a container holder to place the electrically conductive contact on the circuit patch with an end portion of a spring-loaded contact on a lid heating PCB of the container holder. In some cases, the container may be a consumable product that is discarded after a single use. In some cases, the container is a single container or vial. In some cases, the container is in a strip of at least 4, 8, 12, 16, or 24 containers. In some cases, the container is in a strip of 4, 8, 12, 16, or 24 containers. In some cases, the container is a part of a multi-well plate. In some cases, the container is a part of a multi-well plate comprising at least 96, 384, or 1536 wells. In some cases, the container is a part of a multi-well plate. In some cases, the container is a part of a multi-well plate having 96, 384, or 1536 wells. In some cases, the container is a part of a multi-well plate made to SBS standards. In some cases, the container is a part of a multi-well plate, having specifications for use with laboratory automation. In some cases, the container is manufactured by injection molding.

Sometimes, the circuit patch can be provided to the user for the user to adhere to a lid, a covering film, or over a container. Sometimes, the circuit patch is provided adhered to a lid or a covering film for the container.

In some embodiments, the circuit patch is provided to the user for the user to adhere to a lid, a covering film, or over a container. In some embodiments, a plurality of circuit patches is adhered to a plurality of lids by the user. In some embodiments, the plurality of lids is a strip of lids. In some embodiments, the circuit patch is adhered to a lid for the container, where the lid is flexibly attached to the container, by the user. In some embodiments, a plurality of circuit patches is provided for the user to adhere to a covering film, where the covering film can cover a plurality of containers. The user can fill the plurality of containers and then cover the containers with the covering film and then place the circuit patch on top of the covering film. In some embodiments, the plurality of containers is a multiwell plate. In some embodiments, the covering film can be punctured by a pipette tip. In some embodiments, the covering film may be peeled off the container. In some embodiments, the covering film with a plurality of circuit patches can be punctured by a pipette tip or peeled off. In some embodiments, removal of at least a portion of the covering film by puncturing or peeling off or other removal methods allows for collection of the sample in the container.

Sometimes, the circuit patch is provided adhered to a lid or a covering film for the container. In some embodiments, the circuit patch is provided adhered to the lid for the container. In some embodiments, a plurality of circuit patches are provided adhered to a plurality of lids. In some embodiments, the plurality of lids is a strip of lids. In some embodiments, the circuit patch is provided adhered to a lid for the container, where the lid is flexibly attached to the container. In some embodiments, a plurality of circuit patches is provided adhered to a covering film, where the covering film can cover a plurality of containers. The user can fill the plurality of containers and then cover the containers with the covering film having the circuit patch. In some embodiments, the plurality of containers is a multiwell plate. In some embodiments, the covering film can be punctured by a pipette tip. In some embodiments, the covering film with a plurality of circuit patches can be punctured by a pipette tip. In some embodiments, the puncturing of the film allows for collection of the sample in the container.

Provided herein are systems for independent thermocycling for polynucleotide synthesis. The system may comprise a plurality of containers, each individual container having a heating lid or a covering film that is covered on top with a circuit patch, a control system, and a camera. In some embodiments, the circuit patch for one container is independently controlled by the control system from another circuit patch for another container. In some embodiments, the circuit patch has a heating element that is independently controlled by the control system from another heating element for another circuit patch. In some embodiments, the camera comprises a visible light camera. In some embodiments, the camera comprises an infrared camera. In some embodiments, the camera is capable of capturing the plurality of containers placed into the container holder in a single image. In some embodiments, the camera is capable of capturing the plurality of circuit patches on containers placed into the container holder in a single image. In some embodiments, the camera captures only a portion of the plurality of containers placed into the container holder and their circuit patches in a single image. In some embodiments, the camera continually captures images of the plurality of the circuit patches and provides instantaneous information about the temperatures of the patches. In some embodiments, the plurality of sample containers comprises at least 96 sample containers. In some embodiments, the container holder comprises at least 96 openings, wherein each opening is configured to hold a sample container. In some embodiments, the temperature of one container holder is controlled independently from a temperature of another container holder.

Described herein are methods of independent thermocycling for polynucleotide synthesis comprising: a) loading a sample into a container comprising a circuit patch, wherein the circuit patch comprises a heating element, an electrically conductive contact, and a temperature sensor; b) placing the container holding the sample into a container holder of a thermocycler; and c) running a thermocycling protocol on the container, wherein running comprises continually reading a temperature of the lid by the temperature sensor and adjusting the temperature provided by the heating element as needed.

In some embodiments, running a thermocycling protocol on the container further comprises using a camera to detect an identification marking on the lid, matching the detected identification marking with a thermocycling protocol from a database in communication with the thermocycler, assigning the matched thermocycling protocol to the container, and changing the temperature provided by the heating element based the matched thermocycling protocol. In some embodiments, running a thermocycling protocol on the container further comprises using a camera to detect an identification marking on the patch, matching the detected identification marking with a thermocycling protocol from a database in communication with the thermocycler, assigning the matched thermocycling protocol to the container, and changing the temperature provided by the heating element based the matched thermocycling protocol. In some embodiments, the temperature provided by the heating element is changed based on matched thermocycling protocol and the temperature of the patch read by the temperature sensor. In some embodiments, running thermocycling protocol is performed without user input. In some embodiments, running thermocycling protocol is performed automatically after the container is placed into the container holder.

### Thermistor Holder

Provided herein are sensor plate assemblies for thermocycling comprising a plurality of sensor assemblies, a sensor assembly comprising: a ring having an inner perimeter, and a sensor holder having a sensor pad; a plurality of openings for container holders; a plurality of openings for securing sensor assemblies; a plurality of holes for sensor wires; and a circuit board for the sensor plate assembly.

Described herein are sensor assemblies for a sensor plate assembly, the sensor assembly comprising: a ring having an inner perimeter, and a sensor holder having a sensor pad. The sensor assembly described herein may be used with a thermocycler having a capability to control a temperature setting of an individual reaction container independently from a temperature setting of another individual reaction container. So the sensor assembly may allow for accurate and instantaneous detection temperature of individual container in the system. Usually, the sensor holder can hold a sensor in place. Sometimes, the sensor can be a thermistor. In some embodiments, the sensor holder is connected to the ring along the inner perimeter of the ring. In some embodiments, the sensor holder extends upwards from the ring. In some embodiments, the ring surrounds an opening in the sensor plate assembly, where the opening is configured to hold a container holder. In some embodiments, the ring has a flat bottom surface. In some embodiments, the sensor assembly comprises at least two sensor holders that are evenly spaced apart. In some embodiments, the sensor assembly comprises at least two sensor pads that are evenly spaced apart. In some embodiments, the sensor assembly comprises at least 2, 3, 4, 5, 6, 7, 8, 9, or 10 sensor pads. In some embodiments, the sensor assembly comprises no more than 2, 3, 4, 5, 6, 7, 8, 9, or 10 sensor pads. In some embodiments, the sensor assembly has 2 sensor pads that are evenly spaced apart. In some embodiments, the sensor assembly has 3 sensor pads that are evenly spaced apart. In some embodiments, the sensor holder comprises a housing having an opening and a wall. Usually, the ring may be circular in shape having an opening in the center but can be any other shape including but not limited to oval, triangle, rectangle, pentagon, hexagon, heptagon, octagon, decagon. Often, the ring may have an opening in the center to allow for the container holder to be placed through the ring opening.

In some embodiments, the sensor holder has a housing that is shaped to hold the sensor. Often, the sensor holder housing can be a tube shaped, where the tube can be any shape including but not limited to round, rectangle, angled, or oval. Usually the sensor holder housing has an opening to allow the sensor wires to extend out to connect to the thermocycler system. In some embodiments, the housing comprises a tube. In some embodiments, the housing comprises a tapered tube. In some embodiments, the wall of the housing tilts inward toward the center of the ring. In some embodiments, the wall of the housing is at an angle of no more than 10, 20, 30, 40, 50, 60, 70, 80, or 90 degrees relative to a centerline of the ring. In some embodiments, the wall of the housing is at an angle of no more than 90 degrees relative to a centerline of the ring. In some embodiments, the wall of the housing is at an angle of at least 30, 40, 50, 60, 70, 80, 90, 100, 110, 120, 130, 140, 150, 160, 170, or 180 degrees relative to a centerline of the ring. In some embodiments, the housing holds a thermistor and the opening is configured for at least one sensor wire to extend out from the sensor holder.

In some embodiments, the sensor wire connects the thermistor to the sensor plate assembly. In some embodiments, the sensor wire is soldered onto a circuit board for the sensor plate assembly. In some embodiments, the circuit board is a printed circuit board (PCB). In some embodiments, the sensor pad extends from the housing of the sensor holder and contacts an outer surface of a container holder.

Often, the sensor pad can provide for a large surface area for thermal transfer amongst the container holder and the sensor holder and the sensor, where the large surface area improves the efficiency and accuracy of the thermal transfer. In some embodiments, the sensor pad comprises a spring-loaded portion configured to contact the outer surface of the container holder. In some embodiments, the sensor pad applies pressure to the outer surface of the container holder when the container holder placed in the ring, wherein the pressure helps to keep the sensor pad in contact with the outer surface. In some embodiments, the sensor pad comprises a material having flexibility and memory. In some embodiments, the sensor pad comprises a material having a low elastic modulus. In some embodiments, the sensor pad comprises a material having an appropriate elongation. In some embodiments, the sensor pad has a height of at least 1 mm and a length of at least 1 mm. In some embodiments, the sensor pad has a height of at least 0.1, 0.5, 1, 2, 3, 4, 5, 6, 7, 8, 9, or 10 mm. In some embodiments, the sensor pad has a length of at least 0.1, 0.5, 1, 2, 3, 4, 5, 6, 7, 8, 9, or 10 mm. In some embodiments, the sensor pad has a height of no more than 0.5, 1, 2, 3, 4, 5, 6, 7, 8, 9, or 10 mm. In some embodiments, the sensor pad has a length of no more than 0.5, 1, 2, 3, 4, 5, 6, 7, 8, 9, or 10 mm.

In some embodiments, the sensor holder is connected to the ring perpendicularly. In some embodiments, the sensor holder is connected to the ring at an angle no more than 10, 20, 30, 40, 50, 60, 70, 80, or 90 degrees relative to an inner perimeter of the ring. In some embodiments, the sensor holder is connected to the ring at an angle of at least 30, 40, 50, 60, 70, 80, 90, 100, 110, 120, 130, 140, 150, 160, 170, or 180 degrees relative to an inner perimeter of the ring. In some embodiments, the sensor holder is connected to the ring at an angle no more than 90 degrees relative to an inner perimeter of the ring. In some embodiments, the sensor pad is perpendicular to the ring. In some embodiments, the sensor pad is perpendicular to the ring. In some embodiments, the sensor pad is at an angle no more than 10, 20, 30, 40, 50, 60, 70, 80, or 90 degrees relative to an inner perimeter of the ring. In some embodiments, the sensor pad is at an angle of at least 30, 40, 50, 60, 70, 80, 90, 100, 110, 120, 130, 140, 150, 160, 170, or 180 degrees relative to an inner perimeter of the ring. In some embodiments, the sensor pad is at an angle no more than 90 degrees relative to an inner perimeter of the ring.

In some embodiments, the sensor assembly further comprises a support rib. In some embodiments, the support rib provides anti-distortion support. In some embodiments, the support rib provides a spring-loaded support to position a container holder. In some embodiments, the support rib is connected to the ring along the inner perimeter of the ring. In some embodiments, the support rib extends upwards from the ring. In some embodiments, the support rib extends from the ring in same direction as the sensor holder. In some embodiments, the sensor assembly comprises at least 2, 3, 4, 5, 6, 7, 8, 9, or 10 support ribs. In some embodiments, the sensor assembly comprises no more than 2, 3, 4, 5, 6, 7, 8, 9, or 10 support ribs. In some embodiments, the sensor assembly comprises at least 2 support rib that are evenly spaced apart. In some embodiments, the sensor assembly has 2 support ribs that are spaced evenly apart. In some embodiments, the sensor assembly has 3 support ribs that are spaced evenly apart. In some embodiments, the support ribs are radially symmetrically spaced apart. In some embodiments, two support ribs on opposite sides of the ring.

In some embodiments, the sensor assembly comprises a material with high thermal conductivity. In some embodiments, the material comprises at least one of copper, tin, or phosphor bronze, or a combination thereof. In some embodiments, the material comprises a copper alloy. In some embodiments, the material comprises copper beryllium. In some embodiments, the material has thermal conductivity of at least 50, 60, 70, 80, 90, 100, 110, 120, 130, 140, 150, 160, 170, 180, 190, 200, 210, 220, 230, 240, 250, 260, 270, 280, 290, or 300 W/m*K. In some embodiments, the material has thermal conductivity of at least 100 W/m*K. In some embodiments, the material has thermal conductivity of at least 200 W/m*K.

In some embodiments, the sensor assembly further comprises at least two plate securing elements connected to the ring. In some embodiments, the plate securing elements connect to an outer perimeter of the ring. In some embodiments, the plate securing elements extend downward from the ring. In some embodiments, the plate securing elements extend from the ring in opposite direction as the sensor holder. In some embodiments, the plate securing elements are connected to the ring at about 90 degrees relative to the ring. In some embodiments, the plate securing elements have a width of at least 0.5, 1, 2, 3, 4, 5, 6, 7, 8, 9, or 10 mm. In some embodiments, the plate securing elements have a width of no more than 0.5, 1, 2, 3, 4, 5, 6, 7, 8, 9, or 10 mm. In some embodiments, the plate securing elements have a length of at least 0.5, 1, 2, 3, 4, 5, 6, 7, 8, 9, or 10 mm. In some embodiments, the plate securing elements have a length of no more than 0.5, 1, 2, 3, 4, 5, 6, 7, 8, 9, or 10 mm. In some embodiments, the plate securing elements have a thickness of at least 0.01, 0.05, 0.1, 0.2, 0.3, 0.4, 0.5, 0.6, 0.7, 0.8, 0.9, or 1 mm. In some embodiments, the plate securing elements have a thickness of no more than 0.01, 0.05, 0.1, 0.2, 0.3, 0.4, 0.5, 0.6, 0.7, 0.8, 0.9, 1, 2, 3, 4, or 5 mm. In some embodiments, the plate securing elements have a width of at least 1 mm and a length of at least 2 mm. In some embodiments, the plate securing elements have a width of 1 mm and a length of 2 mm. In some embodiments, the plate securing elements fit into securing holes in the sensor plate assembly to secure the sensor assembly onto the sensor plate assembly. In some embodiments, the plate securing elements are sized to have a smaller width than the securing holes. In some embodiments, design of the sensor assembly reduces assembly error in placing the sensor assembly on the sensor plate assembly.

In some embodiments, the sensor assembly is fabricated as a single piece. In some embodiments, the sensor assembly is fabricated by a die and roll form process. In some embodiments, the sensor assembly is fabricated by a coining process. In some embodiments, the single piece for the sensor assembly has thickness of at least 0.01, 0.05, 0.1, 0.2, 0.3, 0.4, 0.5, 0.6, 0.7, 0.8, 0.9, or 1 mm. In some embodiments, the single piece for the sensor assembly has thickness of no more than 0.01, 0.05, 0.1, 0.2, 0.3, 0.4, 0.5, 0.6, 0.7, 0.8, 0.9, 1, 2, 3, 4, or 5 mm.

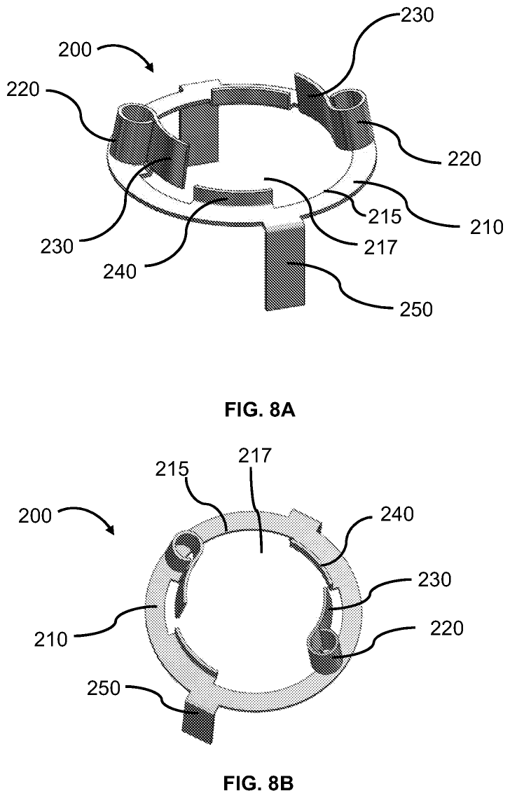

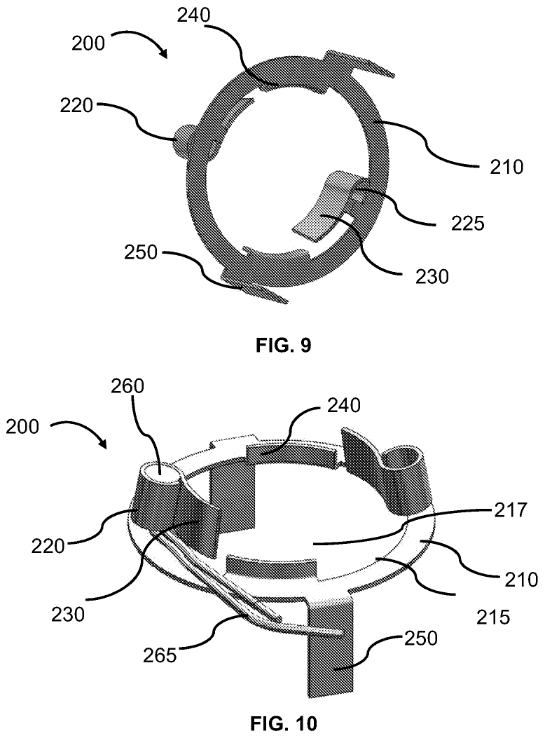

FIG. 8A shows an example of a sensor assembly 200 in an angled top view and FIG. 8B shows an example of the sensor assembly 200 in a top view. FIG. 9 shows an example of a sensor assembly 200 in a bottom view. The sensor assembly comprises a ring 210 having an inner perimeter 215 and an opening 217 that can hold a container holder and a sensor holder 220 having a sensor pad 230 and a sensor holder opening 225. The sensor assembly may have supporting ribs 240 along the ring inner perimeter 215 and plate securing elements 250 along the outer perimeter of the ring.

FIG. 10 shows an example of a sensor assembly 200 with a sensor 260, which can be a thermistor, in the sensor holder in an angled top view. The sensor assembly comprises a ring 210 having an inner perimeter 215 and an opening 217 that can hold a container holder and a sensor holder 220 having a sensor pad 230 and a sensor holder opening 225. The sensor 260 is held securely by the sensor holder 220, and the sensor wires 265 extend out of the sensor holder 220 from the sensor holder opening 225 as shown in FIG. 9. The sensor assembly may have supporting ribs 240 along the ring inner perimeter 215 and plate securing elements 250 along the outer perimeter of the ring.

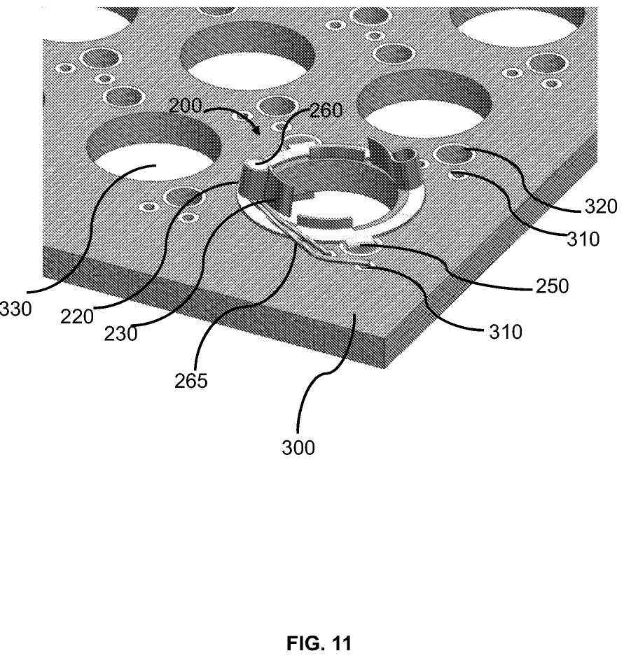

FIG. 11 shows a close up view of an example of a sensor assembly 200 assembled on a plate assembly having a printed circuit board 300. The sensor assembly has a sensor holder 220 having a sensor pad 230 and a sensor 260 that is held securely by the sensor holder 220. The sensor wires 265 from the sensor 260 extend out of the sensor holder 220 and is passed through holes for the sensor wires 310 to be connected to the PCB sensor contact. The plate assembly with PCB 300 has a plurality of holes for container holder 330 and a plurality of holes 320 for the plate securing elements 250 to pass through and secure the sensor assembly 200 to the plate assembly 300.

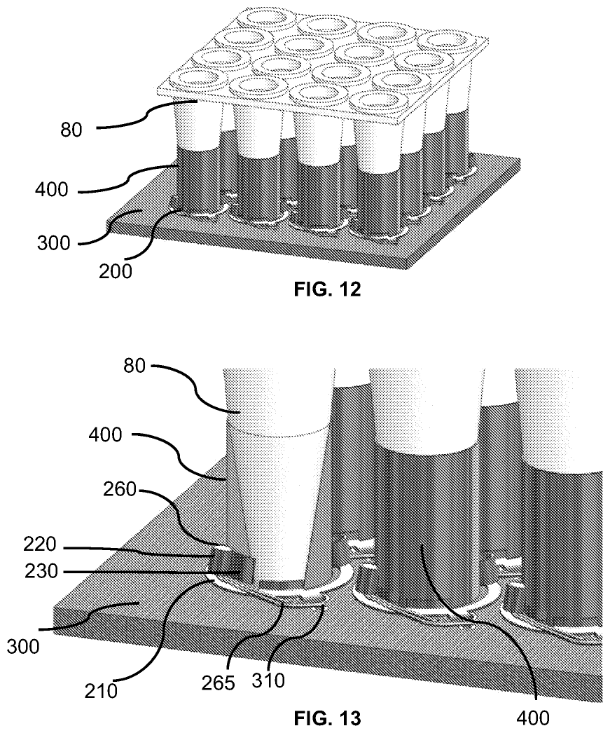

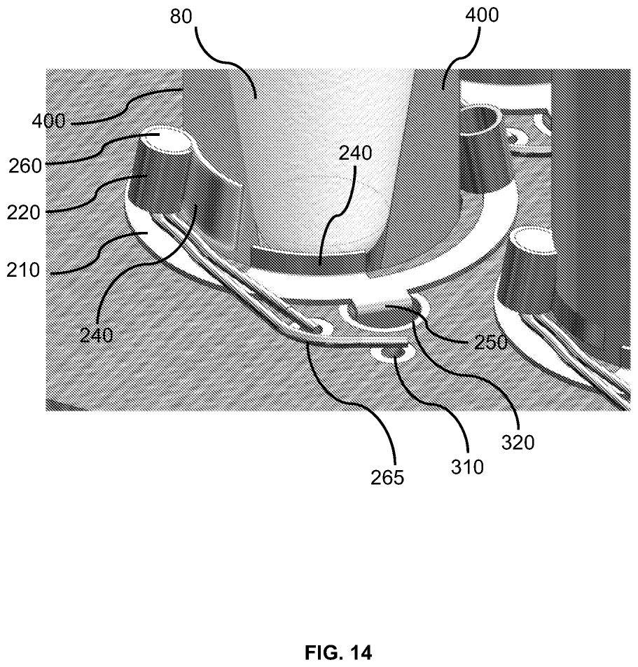

FIG. 12 shows an example of a plurality of sensor assemblies 200 assembled on a plate assembly 300 with a plurality of container holders 400 and a plurality of containers 80. FIG. 13 shows a close up view of an example of a sensor assembly on a plate assembly. The plate assembly PCB 300 has a plurality of holes for container holder 330 and a plurality of holes 320 for the plate securing elements 250 to pass through and secure the sensor assembly 200 to the plate assembly 300. The sensor assembly has a ring 210 and a sensor holder 220, where the sensor 260 is held securely by the sensor holder 220. The sensor pad 230 extending from the housing of the sensor holder 220 is in direct contact with the container holder 400 and spring-loaded to apply pressure to and maintain the contact with the outer surface of the container holder 400. The sensor may be a thermistor to detect the temperature of the container holder, which is a proxy for the temperature of the container and the sample contained therein. The sensor wires 265 from the sensor 260 extend out of the sensor holder 220 and is passed through holes for the sensor wires 310 to be connected to the PCB sensor contact. The sensor wire transmits the temperature information from the sensor (e.g. thermistor) to the thermocycler, which can use the information to provide commands to the thermoelectric module to heat the container, cool the container using the heat sink, and/or heat the patch to adjust the temperature for the individual container as needed.

FIG. 14 shows a close up view of FIG. 13, providing an example of a sensor assembly on a plate assembly. The plate assembly PCB 300 has a plurality of a plurality of holes for sensor wires 310, a plurality of holes for container holder 330 and a plurality of holes 320 for the plate securing elements 250 to pass through and secure the sensor assembly 200 to the plate assembly 300. The sensor assembly has a ring 210 and a sensor holder 220, where the sensor 260 is held securely by the sensor holder 220. The sensor pad 230 extending from the housing of the sensor holder 220 is spring-loaded to apply pressure to and maintain the contact with the outer surface of the container holder 400 holding a container 80. The sensor wires 265 from the sensor 260 extend out of the sensor holder 220 and is passed through holes for the sensor wires 310 to be connected to the PCB sensor contact.

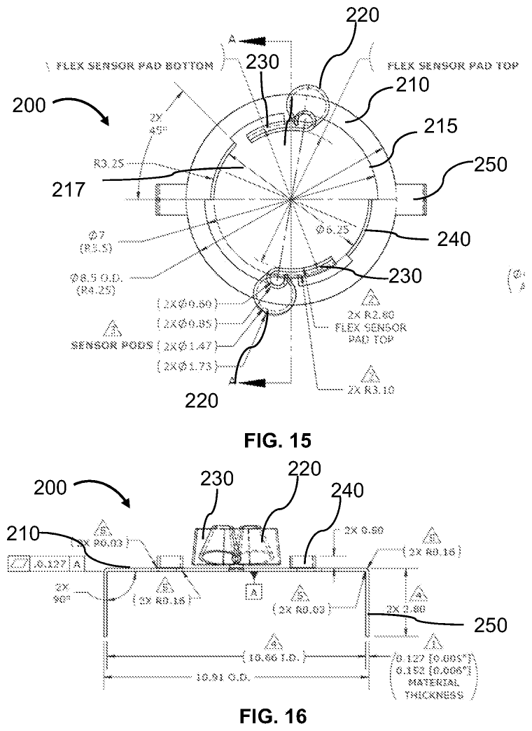

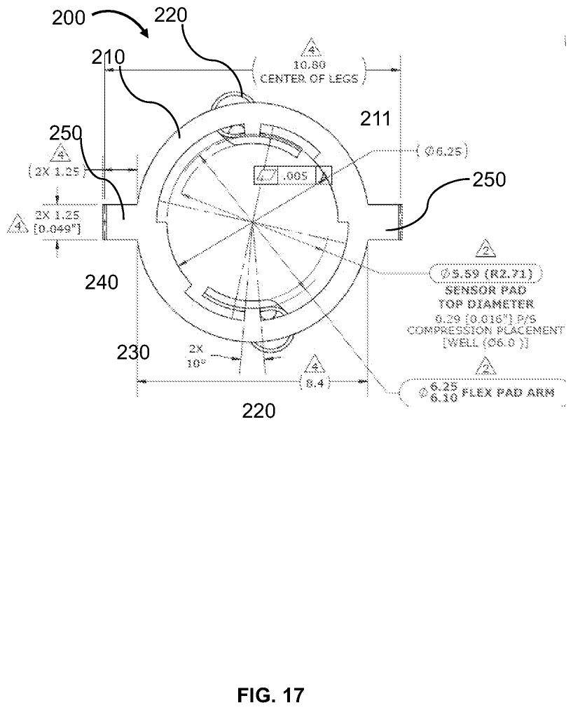

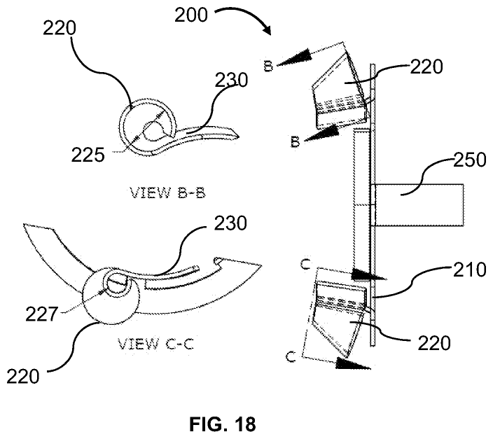

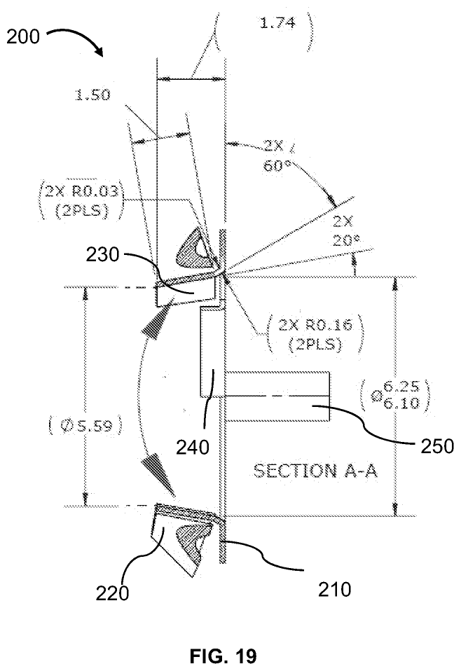

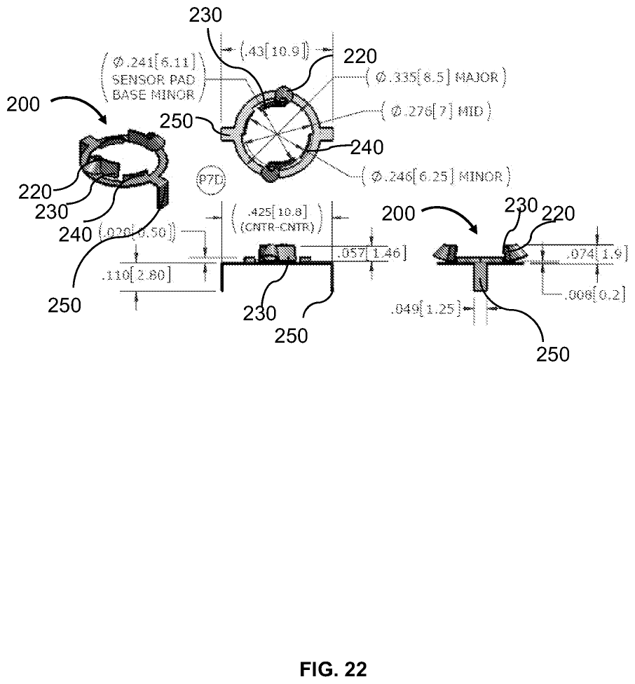

FIG. 15 shows an example of a sensor assembly 200 in a top view. FIG. 16 shows an example of a sensor assembly 200 in a side view. FIG. 17 shows an example of a sensor assembly 200 in a bottom view. FIG. 18 shows an example of a sensor assembly 200 in a side view and of the sensor holder 220 in tope view and bottom view. FIG. 19 also shows an example of a sensor assembly 200 in a side view. FIG. 22 also shows an example of a sensor assembly in an angled view, top view, and side views. The housing for the sensor holder 220 on the ring 210 may be a tapered tube having a diameter of the bottom portion of the housing 225 that is different from a diameter of the upper portion of the housing 227. In some embodiments, the diameter of the bottom portion of the housing is larger than the diameter of the upper portion of the housing. In some embodiments, the diameter of the bottom portion of the housing is smaller than the diameter of the upper portion of the housing. In some embodiments, the diameter of the bottom portion of the housing are the same as the diameter of the upper portion of the housing. The housing for the sensor holder 220 has a sensor pad 230 extending from it. The sensor assembly 200 has supporting ribs 240 and plate securing elements 250.

In some embodiments, the distance between the top portion of the two sensor holders are at least 1, 2, 3, 4, 5, 6, 7, 8, 9, or 10 mm. In some embodiments, the distance between the top portion of the two sensor holders are about 5.6 mm. In some embodiments, the distance between the bottom portion of the two sensor holders are at least 1, 2, 3, 4, 5, 6, 7, 8, 9, or 10 mm. In some embodiments, the distance between the bottom portion of the two sensor holders are about 6.1 mm. In some embodiments, the distance between the bottom portion of the two sensor holders are about 6.25 mm. In some embodiments, the height of the sensor holders is at least 0.1, 0.5, 1, 2, 3, 4, or 5 mm. In some embodiments, the height of the sensor holders is about 1.5 mm. In some embodiments, the sensor holder is angled inward at least at 5, 10, 15, 20, 25, 30, 40, 50, 60, 70, 80, or 90 degrees from a vertical axis when at rest (e.g. without a container holder placed through the ring opening). In some embodiments, the sensor holders is angled inward at 10 degrees from a vertical axis at rest. In some embodiments, the sensor pad is angled inward at least at 5, 10, 15, 20, 25, 30, 40, 50, 60, 70, 80, or 90 degrees from a vertical axis when at rest (e.g. without a container holder placed through the ring opening). In some embodiments, the sensor pad is angled inward at 10 degrees from a vertical axis at rest. In some embodiments, the sensor pad is angled inward at a smaller angle when a container holder is placed through the ring opening and in contact with the sensor pad than when at rest. In some embodiments, the flexibility of the sensor pad allows for a change of angle of the sensor pad to a smaller angle when a container holder through the ring opening and in contact with the sensor pad. In some embodiments, the diameter of the bottom portion of the housing 225 is at least 0.5, 0.6, 0.7, 0.8, 0.9, 1.0, 1.1, 1.2, 1.3, 1.4, 1.5, 1.6, 1.7, 1.8, 1.9, 2, 2.5, 3, 3.5, or 4 mm. In some embodiments, the diameter of the bottom portion of the housing 225 is about 1.5 mm. In some embodiments, the diameter of the bottom portion of the housing 225 is about 1.7 mm. In some embodiments, the diameter of the diameter of the upper portion of the housing 22 is at least 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 mm. In some embodiments, the diameter of the diameter of the upper portion of the housing 22 is about 0.6 mm. In some embodiments, the diameter of the diameter of the upper portion of the housing 22 is about 0.85 mm. In some embodiments, the opening of the ring has a diameter of at least 1, 2, 3, 4, 5, 6, 7, 8, 9, or 10 mm. In some embodiments, the opening of the ring has a diameter of about 7 mm. In some embodiments, the outer diameter of the ring is at least 5, 5.5, 6, 6.5, 7, 7.5, 8, 8.5, 9, 9.5, 10, 10.5, 11, 11.5, 12, 12.5, 13, 13.5, 14, 14.5, or 15 mm. In some embodiments, the outer diameter of the ring is about 8.5 mm. In some embodiments, the distance between the plate securing elements, also referred to as legs, is at least 5, 6, 7, 8, 9, 10, 11, 12, 13, 14, or 15 mm. In some embodiments, the distance between the plate securing elements is about 5, 6, 7, 8, 9, 10, 11, 12, 13, 14, or 15 mm. In some embodiments, the distance between the plate securing elements is about 11 mm. In some embodiments, the plate securing elements extends out from the outer perimeter of the ring for at least about 0.5, 1, 2, 3, 4, or 5 mm. In some embodiments, the plate securing elements extends out from the outer perimeter of the ring for about 1.25 mm. In some embodiments, the plate securing elements extends out from the outer perimeter of the ring for about 1 mm.

In some embodiments, the sensor holder is angled at least about 5, 10, 15, 20, 25, 30, 40, 50, 60, 70, 80, or 90 degrees from the plate securing element. In some embodiments, the sensor holder is angled about 5, 10, 15, 20, 25, 30, 40, 50, 60, 70, 80, or 90 degrees from the plate securing element. In some embodiments, the sensor holder is angled about 90 degrees from the plate securing element. In some embodiments, the farther end of the supporting rib is angled at least about 5, 10, 15, 20, 25, 30, 40, 50, 60, 70, 80, or 90 degrees from the plate securing element. In some embodiments, the farther end of the supporting rib is angled about 5, 10, 15, 20, 25, 30, 40, 50, 60, 70, 80, or 90 degrees from the plate securing element. In some embodiments, the farther end of the supporting rib is angled about 45 degrees from the plate securing element. In some embodiments, the closer end of the supporting rib is angled about 0, 5, 10, 15, 20, 25, 30, 40, 50, 60, 70, 80, or 90 degrees from the plate securing element. In some embodiments, the closer end of the supporting rib is angled about 0 degree from the plate securing element.

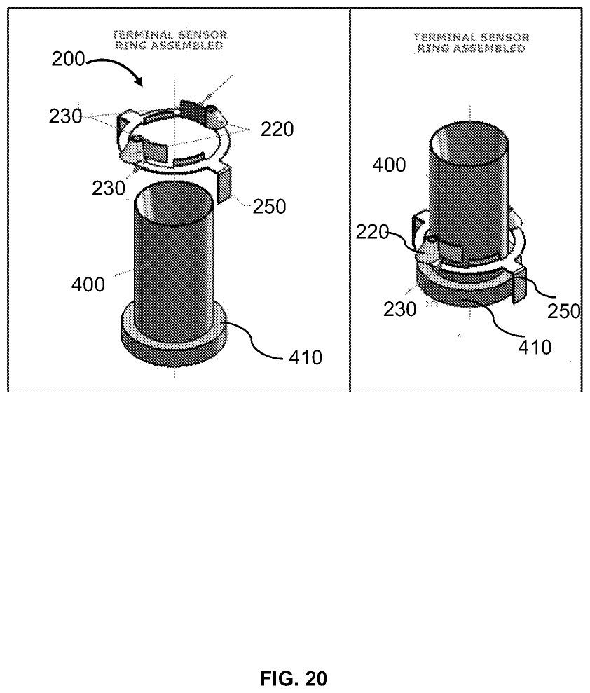

FIG. 20 shows an example of a sensor assembly 200 assembled with a container holder 400. The sensor assembly 200 has a sensor holder 220, where the sensor can be held securely by the sensor holder 220, with a sensor pad 230 extending from the sensor holder. The sensor pad 230 extending from the housing of the sensor holder 220 is spring-loaded to apply pressure to and maintain the contact with the outer surface of the container holder 400. The container holders 400 has a container holder bottom 410 that has a larger diameter than the rest of the container holder 400, which prevents the sensor assembly 200 from falling off the container holder 400 and helps to secure the sensor assembly 200. In some embodiments, the container holder 400 has a diameter of at least 2, 3, 4, 5, 6, 7, 8, 9, or 10 mm. In some embodiments, the container holder 400 has a diameter of about 6 mm.

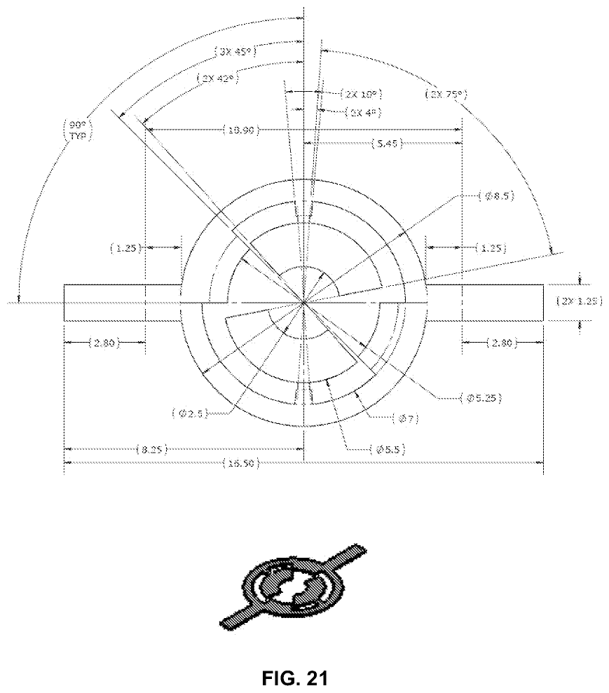

FIG. 21 shows an example of a sensor assembly cutout design. This may be cut out into a single piece and then shaped into a 3-dimensional shape of the sensor assembly 200.

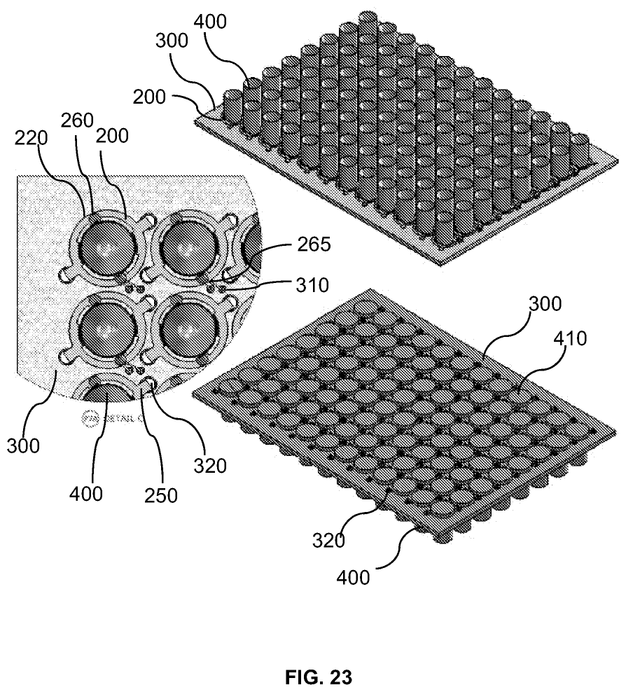

FIG. 23 shows an example of a plurality of sensor assemblies 200 with a plurality of container holders 400 assembled on a plate assembly 300 in a top view, a bottom view, and a close up top view. The various views show the plurality of container holders 400 on either side of the plate assembly PCB 300 with a plurality of container holder bottoms 410 on the bottom side of the plate assembly PBC 300, where a container holder bottom 410 has a larger diameter than the rest of the container holder 400. The top side of plate assembly PCB 300 may have the plurality of sensor assemblies 200 and the plurality the container holders 400 passing through the holes for the container holders on the plate assembly PBC. Similarly to FIGS. 13 and 14, the plate assembly PCB 300 has a plurality of a plurality of holes for sensor wires 310, a plurality of holes for container holder, and a plurality of holes 320 for the plate securing elements 250 to pass through and secure the sensor assembly 200 to the plate assembly 300. The sensor assembly has a sensor holder 220, where the sensor 260 is held securely by the sensor holder 220. The sensor wires 265 from the sensor 260 extend out of the sensor holder 220 and is passed through holes for the sensor wires 310 to be connected to the PCB sensor contact.

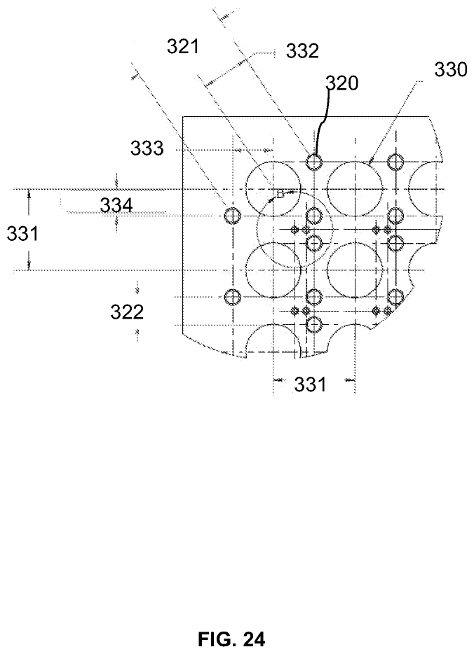

FIG. 24 shows an example of a design layout for a PCB plate having a plurality of holes for the sensor assembly and sensor wires. The plate assembly PCB 300 may have a plurality of holes for sensor wires 310, a plurality of holes for container holder 330, and a plurality of holes 320 for the plate securing elements to pass through and secure the sensor assembly to the plate assembly 300. In some embodiments, the holes for container holder 330 has a diameter of about 6.1 mm. In some embodiments, the holes for container holder 330 has a diameter of about 0.24 inch. In some embodiments, the holes for container holder 330 has a diameter of at least 1, 2, 3, 4, 5, 6, 7, 8, 9, or 10 mm. In some embodiments, the holes for container holder 330 has a diameter of no more than 1, 2, 3, 4, 5, 6, 7, 8, 9, or 10 mm. In some embodiments, the holes for container holder 330 has a diameter of at least 0.01, 0.05, 0.1, 0.2, 0.3, 0.4, 0.5, 0.6, 0.7, 0.8, 0.9, or 1 inch. In some embodiments, the holes for container holder 330 has a diameter of no more than 0.05, 0.1, 0.2, 0.3, 0.4, 0.5, 0.6, 0.7, 0.8, 0.9, or 1 inch. In some embodiments, the center-to-center distance 331 between two holes for container holder 330 is about 9 mm. In some embodiments, the center-to-center distance 331 between two holes for container holder 330 is about 0.354 inch. In some embodiments, the center-to-center distance 331 between two holes for container holder 330 is at least 5, 6, 7, 8, 9, 10, 11, 12, 13, 14, or 15 mm. In some embodiments, the center-to-center distance 331 between two holes for container holder 330 is no more than 5, 6, 7, 8, 9, 10, 11, 12, 13, 14, or 15 mm. In some embodiments, the center-to-center distance 331 between two holes for container holder 330 is at least 0.05, 0.1, 0.2, 0.3, 0.4, 0.5, 0.6, 0.7, 0.8, 0.9, or 1 inch. In some embodiments, the center-to-center distance 331 between two holes for container holder 330 is no more than 0.1, 0.2, 0.3, 0.4, 0.5, 0.6, 0.7, 0.8, 0.9, or 1 inch. In some embodiments, the center to center distance 332 between hole for container holder 330 and hole for securing the sensor assembly 320 is about 5.4 mm or 0.212 inches. In some embodiments, the center-to-center distance 332 between hole for container holder 330 and hole for securing the sensor assembly 320 is at least 1, 2, 3, 4, 5, 6, 7, 8, 9, or 10 mm. In some embodiments, the x-direction offset 333 of the center for hole for container holder 330 from the center of the hole for securing the sensor assembly 320 is about 4.5 mm or about 0.178 inch. In some embodiments, the x-direction offset 333 is at least 1, 2, 3, 4, 5, 6, 7, 8, 9, or 10 mm. In some embodiments, the x-direction offset 333 is at least 0.05, 0.1, 0.2, 0.3, 0.4, or 0.5 inch. In some embodiments, the y-direction offset 334 of the center for hole for container holder 330 from the center of the hole for securing the sensor assembly 320 is about 2.97 mm or about 0.117 inch. In some embodiments, the y-direction offset 334 is at least 1, 2, 3, 4, 5, 6, 7, 8, 9, or 10 mm. In some embodiments, the y-direction offset 334 is at least 0.05, 0.1, 0.2, 0.3, 0.4, or 0.5 inch. In some embodiments, the center to center distance 321 between the holes for securing the sensor assembly 320 is about 10.8 mm or 0.425 inches. In some embodiments, the center to center distance 321 between the holes for securing the sensor assembly 320 is at least 5, 6, 7, 8, 9, 10, 11, 12, 13, 14, or 15 mm. In some embodiments, the y-direction offset 322 of the centers of the holes for securing the sensor assembly 320 is about 3.06 mm or about 0.12 inch. In some embodiments, the y-direction offset 322 of the centers of the holes for securing the sensor assembly 320 is at least 1, 2, 3, 4, 5, or 6 mm. In some embodiments, the y-direction offset 322 of the centers of the holes for securing the sensor assembly 320 is at least 0.05, 0.1, 0.2, 0.3, 0.4, or 0.5 inch.

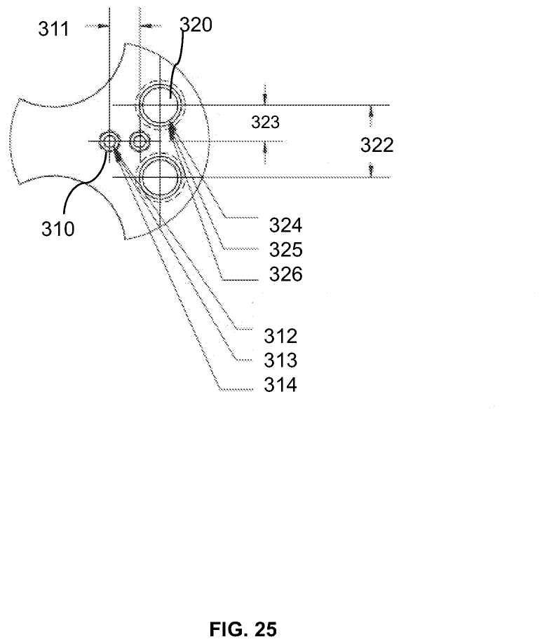

FIG. 25 shows an example of a close up of the design layout for a PCB plate having a plurality of holes for the sensor assembly and sensor wires from FIG. 24. The close up view of the plate assembly PCB shows a plurality of holes for sensor wires 310 and a plurality of holes 320 for the plate securing elements to pass through and secure the sensor assembly. In some embodiments, the y-direction offset distance of centers of holes for securing sensor assembly 322 is about 3.06 mm or about 0.12 inch. In some embodiments, the y-direction offset distance of centers of holes for securing sensor assembly 322 is at least 1, 2, 3, 4, or 5 mm. In some embodiments, the y-direction offset of center of hole for securing sensor assembly and center of hole for sensor wire 323 is about 1.53 mm or about 0.06 inch. In some embodiments, the y-direction offset of center of hole for securing sensor assembly and center of hole for sensor wire 323 is at least 0.1, 0.5, 1, 2, 3, 4, or 5 mm. In some embodiments, the center to center distance between holes for sensor wires 311 is about 1.27 mm or about 0.05 inch. In some embodiments, the center to center distance between holes for sensor wires 311 is at least 0.1, 0.5, 1, 2, or 3 mm. As shown, the through hole for the sensor securing element 320 has a leg hole 324, a leg pad on the top side 325, and a leg pad on the bottom side 326. In some embodiments, the leg hole 324 has a diameter of about 1.5 mm or 0.059 inch. In some embodiments, the leg hole 324 has a diameter of at least 0.5, 6, 0.7, 0.8, 0.9, 1, 1.5, 2, 2.5, 3, 3.5, or 4 mm. In some embodiments, the leg pad on the top side 325 has a diameter of about 1.8 mm or 0.071 inch. In some embodiments, the leg pad on the top side 325 has a diameter of at least 0.5, 6, 0.7, 0.8, 0.9, 1, 1.5, 2, 2.5, 3, 3.5, or 4 mm. In some embodiments, the leg pad on the bottom side 326 has a diameter of about 2.1 mm or 0.083 inch. In some embodiments, the leg pad on the bottom side 326 has a diameter of at least 0.5, 6, 0.7, 0.8, 0.9, 1, 1.5, 2, 2.5, 3, 3.5, 4, 4.5, or 5 mm. The through hole for the sensor wires 310 may have a wire hole 312, a wire pad on the top side 313, and a wire pad on the bottom side 314. In some embodiments, the wire hole 312 is sized for a 32 American wire gauge (AWG) wire to pass through. In some embodiments, the wire hole 312 is sized for a 30, 31, 32, 33, 34, or 35 AWG wire to pass through. In some embodiments, the sensor wire is a 30, 31, 32, 33, 34, or 35 AWG wire. In some embodiments, the wire hole 312 has a diameter of about 0.51 mm or about 0.02 inch. In some embodiments, the wire hole 312 has a diameter of at least 0.01, 0.05, 0.1, 0.2, 0.3, 0.4, 0.5, 0.6, 0.7, 0.8, 0.9, or 1 mm. In some embodiments, the wire pad on the top side 313 has a diameter of at least 0.01, 0.05, 0.1, 0.2, 0.3, 0.4, 0.5, 0.6, 0.7, 0.8, 0.9, or 1 mm. In some embodiments, the wire pad on the top side 313 has a diameter of about 0.8 mm or 0.032 inch. In some embodiments, the wire pad on the bottom side 314 has a diameter of at least 0.01, 0.05, 0.1, 0.2, 0.3, 0.4, 0.5, 0.6, 0.7, 0.8, 0.9, or 1 mm. In some embodiments, the wire pad on the bottom side 314 has a diameter of about 0.9 mm or 0.036 inch.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

The terms “about” and “approximately” mean within an acceptable error range for the particular value as determined by one of ordinary skill in the art, which will depend in part on how the value is measured or determined, such as the limitations of the measurement system. For example, “about” can mean within 1 or more than 1 standard deviation, per the practice in the art. Alternatively, “about” can mean a range of up to 20%, up to 10%, up to 5%, or up to 1% of a given value. Where particular values are described in the application and claims, unless otherwise stated, the term “about,” meaning within an acceptable error range for the particular value, should be assumed.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

As used in the specification and claims, the singular forms “a”, “an” and “the” include plural references unless the context clearly dictates otherwise. For example, the term “a sample” includes a plurality of samples, including mixtures thereof.

As used herein, the terms “polynucleotide”, “nucleic acid,” “oligonucleotide,” and “gene” are used interchangeably. They refer to a polymeric form of nucleotides of any length, either deoxyribonucleotides or ribonucleotides, or analogs thereof. The following are non-limiting examples of polynucleotides: coding or non-coding regions of a gene or gene fragment, loci (locus) defined from linkage analysis, exons, introns, isolated DNA of any sequence, cDNA, recombinant polynucleotides, branched polynucleotides, plasmids, vectors, isolated RNA of any sequence, messenger RNA (mRNA), transfer RNA (tRNA), ribosomal RNA (rRNA), short interfering RNA (siRNA), short-hairpin RNA (shRNA), micro-RNA (miRNA), ribozymes, nucleic acid probes, and primers. A polynucleotide may comprise one or more modified nucleotides, such as methylated nucleotides and nucleotide analogs. If present, modifications to the nucleotide structure may be imparted before or after assembly of the polymer. The sequence of nucleotides may be interrupted by non-nucleotide components. A polynucleotide may be further modified after polymerization, such as by conjugation with a labeling component. Generally, oligonucleotides as used herein are shorter than polynucleotides.

The term “polynucleotide synthesis,” as used herein, refers to polynucleotide synthesis, gene synthesis, or polynucleotide assembly. Polynucleotide synthesis refers to the process of covalently linking a nucleotide to another to another nucleotide, an oligonucleotide to another oligonucleotide, or a nucleotide to an oligonucleotide to generate a strand of nucleic acids, oligonucleotides, or polynucleotides.

As used herein, the terms “container,” “vial,” “well,” and “chamber” are used interchangeably. A container refers to a vessel capable of holding reagents for the polynucleotide synthesis.

The section headings used herein are for organizational purposes only and are not to be construed as limiting the subject matter described.

### EXAMPLES

The following examples are included for illustrative purposes only and are not intended to limit the scope of the invention.

### Example 1: Circuit Patch Film

Provided herein is an exemplary embodiment of a circuit patch film. The patch film is a top lamination of plate seals. The layers for the heating seal comprising the patch film would be the following:

Layer 1. Adhesive Layer. This layer provides for adhesion to microtiter plate. This layer may be pressure sensitive or thermal adhesive.

Layer 2. Sealing layer. This layer provides barrier to water vapor. This may be a heat resistant polymer.

Layer 3. Circuit patch Film Layer comprising Layers 3A-3D.

Layer 3A. Adhesive layer.

Layer 3B. Heater layer. This layer comprises an internal heater, electrical contacts, and a temperature sensor.

Layer 3C. Substrate layer.

Layer 3D. Printed layer. This layer comprises thermochromic ink and a QR code.

The heating seal may be applied by the user after the microtiter plate is filled. The user can access any one of the samples in the microtiter plate by puncturing the seal with a pipette and aspirating the contents of that well without interfering with the temperature processes occurring in the other wells on the plate.

### Example 2: Circuit Patch Lid

Provided herein is an exemplary embodiment of a circuit patch adhered to the lid when provided to the user. The product provided to an end user is a custom plastic PCR tube having an integrated patch. The heating patch is already applied to the lid of the container, and the user closes the lid onto the container.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### Exemplary Embodiments

Among the exemplary embodiments are:

Embodiment 1 comprises a circuit patch for heating a lid of a container comprising at least one of a resistive heating element, an electrically conductive printed contact, or a temperature sensing element, or a combination thereof. Embodiment 2 comprises the circuit patch of embodiment 1, wherein the circuit patch is placed on a top portion of the lid. Embodiment 3 comprises the circuit patch of embodiment 2, wherein the circuit patch has an adhesive surface that is placed on the top portion of the lid. Embodiment 4 comprises the circuit patch of embodiment 1, wherein the circuit patch is directly molded into the lid. Embodiment 5 comprises the circuit patch of any one of embodiments 1-4, wherein the resistive heating element is embedded in the circuit patch. Embodiment 6 comprises the circuit patch of any one of embodiments 1-5, wherein the resistive heating element is an electrically conductive printed contact. Embodiment 7 comprises the circuit patch of any one of embodiments 1-6, wherein the resistive heating element changes the temperature of the lid. Embodiment 8 comprises the circuit patch of any one of embodiments 1-7, wherein the resistive heating element has a temperature range from 50 □C to 110 □C. Embodiment 9 comprises the circuit patch of any one of embodiments 1-8, wherein the circuit patch comprises at least two electrically conductive printed contact. Embodiment 10 comprises the circuit patch of any one of embodiments 1-9, wherein the electrically conductive printed contact is placed near the perimeter of the lid. Embodiment 11 comprises the circuit patch of any one of embodiments 1-10, wherein the electrically conductive printed contact is placed on top of a hole near the perimeter of the lid. Embodiment 12 comprises the circuit patch of any one of embodiments 1-11, wherein the hole is configured to fit an end portion of a spring-loaded contact on a lid heating printed circuit board (PCB) of a container holder when the container is placed in the container holder and the lid closes the open end of the container. Embodiment 13 comprises the circuit patch of any one of embodiments 1-12, wherein the spring-loaded contact has a diameter of no more than 0.5 mm. Embodiment 14 comprises the circuit patch of any one of embodiments 1-13, wherein the electrically conductive printed contact comes into contact with an end portion of a spring-loaded contact on a container holder when the container is placed in the container holder and the lid closes the open end of the container. Embodiment 15 comprises the circuit patch of any one of embodiments 1-14, wherein the electrically conductive printed contact is spaced apart from the resistive heating element. Embodiment 16 comprises the circuit patch of any one of embodiments 1-15, wherein the temperature sensing element comprises at least one of a thermistor, a thermocouple, a resistance temperature detector (RTD), or a thermochromic sticker, or a combination thereof. Embodiment 17 comprises the circuit patch of any one of embodiments 1-16, wherein the thermistor is a thin film thermistor. Embodiment 18 comprises the circuit patch of any one of embodiments 1-17, wherein the temperature sensing element is capable of detecting a temperature range from 50 □C to 110□C. Embodiment 19 comprises the circuit patch of any one of embodiments 1-18, wherein the thermochromic sticker is capable of detecting a temperature range from 50□C to 110□C. Embodiment 20 comprises the circuit patch of any one of embodiments 1-19, wherein the thermochromic sticker changes color as a temperature of the circuit patch changes. Embodiment 21 comprises the circuit patch of any one of embodiments 1-20, wherein the color change of the thermochromic sticker is captured by a camera. Embodiment 22 comprises the circuit patch of any one of embodiments 1-21, wherein the camera comprises a visible light camera. Embodiment 23 comprises the circuit patch of any one of embodiments 1-22, wherein the camera comprises an infrared camera. Embodiment 24 comprises the circuit patch of any one of embodiments 1-23, wherein a control system uses color change to check temperature of the lid heated by the resistive heating element and makes changes to heating by the resistive heating element as needed. Embodiment 25 comprises the circuit patch of any one of embodiments 1-24, wherein a control system uses a reading by the temperature sensing element to control temperature of the resistive heating element. Embodiment 26 comprises the circuit patch of any one of embodiments 1-25, wherein a control system uses temperature sensing element to check temperature of the lid heated by the resistive heating element and makes changes to heating by the resistive heating element as needed. Embodiment 27 comprises the circuit patch of any one of embodiments 1-26, wherein the control system makes changes to heating by the resistive heating element without user input. Embodiment 28 comprises the circuit patch of any one of embodiments 1-27, wherein the temperature sensing element is placed on a top surface of the circuit patch. Embodiment 29 comprises the circuit patch of any one of embodiments 1-28, wherein the temperature sensing element is placed on top of the resistive heating element. Embodiment 30 comprises the circuit patch of any one of embodiments 1-29, wherein the temperature sensing element is offset from the resistive heating element and near a perimeter of the lid. Embodiment 31 comprises the circuit patch of any one of embodiments 1-30, wherein the circuit patch or the container comprises a unique marking. Embodiment 32 comprises the circuit patch of any one of embodiments 1-31, wherein the unique marking comprises a QR code. Embodiment 33 comprises the circuit patch of any one of embodiments 1-32, wherein the unique marking comprises an RFID identifier. Embodiment 34 comprises the circuit patch of any one of embodiments 1-33, wherein the unique marking comprises an identification information. Embodiment 35 comprises the circuit patch of any one of embodiments 1-34, wherein the identification information comprises at least one of a sample information, a protocol information, or a temperature protocol information, or a combination thereof. Embodiment 36 comprises the circuit patch of any one of embodiments 1-35, wherein the unique marking is readable by a camera. Embodiment 37 comprises the circuit patch of any one of embodiments 1-36, wherein the circuit patch has a thickness of no more than 0.5 mm. Embodiment 38 comprises the circuit patch of any one of embodiments 1-37, wherein the circuit patch has a thickness of about 0.35 mm. Embodiment 39 comprises the circuit patch of any one of embodiments 1-38, wherein the lid comprises a plastic. Embodiment 40 comprises the circuit patch of any one of embodiments 1-39, wherein the plastic comprises at least one of polyethylene, polypropylene, or a combination thereof. Embodiment 41 comprises the circuit patch of any one of embodiments 1-40, wherein the lid made by injection molding. Embodiment 42 comprises the circuit patch of any one of embodiments 1-41, wherein the lid is connected to another lid in a lid strip. Embodiment 43 comprises the circuit patch of any one of embodiments 1-42, wherein the lid strip comprises 4, 8, 12, 24, 48, 96, 128, 384, or 1536 lids. Embodiment 44 comprises the circuit patch of any one of embodiments 1-43, wherein the heating element of the lid in the lid strip is controlled independently from a heating element of a neighboring lid by a control system. Embodiment 45 comprises the circuit patch of any one of embodiments 1-44, wherein the container is connected to another container in a plurality of containers. Embodiment 46 comprises the circuit patch of any one of embodiments 1-45, wherein the plurality of containers comprises at least 4, 8, 12, 24, 48, 96, 128, 384, or 1536 containers. Embodiment 47 comprises the circuit patch of any one of embodiments 1-46, wherein the plurality of containers comprises 4, 8, 12, 24, 48, 96, 128, 384, or 1536 containers. Embodiment 48 comprises the circuit patch of any one of embodiments 1-47, wherein the plurality of containers is a multiwell plate. Embodiment 49 comprises the circuit patch of any one of embodiments 1-48, wherein the plurality of containers is consumable. Embodiment 50 comprises the circuit patch of any one of embodiments 1-49, wherein the circuit patch is in a layer of a plurality of circuit patches. Embodiment 51 comprises the circuit patch of any one of embodiments 1-50, wherein the circuit patch in the plurality of circuit patches is spaced to match the spacing of a plurality of containers. Embodiment 52 comprises the circuit patch of any one of embodiments 1-51, wherein the plurality of circuit patches comprises 4, 8, 12, 24, 48, 96, 128, 384, or 1536 circuit patches. Embodiment 53 comprises the circuit patch of any one of embodiments 1-52, wherein the layer of the plurality of circuit patches comprises an adhesive layer. Embodiment 54 comprises the circuit patch of any one of embodiments 1-53, wherein the adhesive layer allows for adhesion the plurality of containers. Embodiment 55 comprises the circuit patch of any one of embodiments 1-54, wherein layer of the plurality of circuit patches comprises an adhesive layer, a sealing layer, and a circuit layer. Embodiment 56 comprises the circuit patch of any one of embodiments 1-55, wherein the adhesive layer allows for adhesion the plurality of containers. Embodiment 57 comprises the circuit patch of any one of embodiments 1-56, wherein the adhesive layer comprises at least one of a pressure sensitive adhesive or a thermal adhesive. Embodiment 58 comprises the circuit patch of any one of embodiments 1-57, wherein the sealing layer provides a barrier to water vapor. Embodiment 59 comprises the circuit patch of any one of embodiments 1-58, wherein the sealing layer comprises a heat-resistant polymer. Embodiment 60 comprises the circuit patch of any one of embodiments 1-59, wherein the flexible circuit layer comprises an adhesive layer, a heater layer, a substrate layer, and a printed layer. Embodiment 61 comprises the circuit patch of any one of embodiments 1-60, wherein the heater layer comprises a resistive heating element, an electrically conductive contact, and a temperature sensor. Embodiment 62 comprises the circuit patch of any one of embodiments 1-61, wherein the printed layer comprises a thermochromic ink patch and an identification marking. Embodiment 63 comprises the circuit patch of any one of embodiments 1-62, wherein the identification marking comprises a QR code. Embodiment 64 comprises the circuit patch of any one of embodiments 1-63, wherein the lid and the container are made from the same material. Embodiment 65 comprises thecircuit patch of any one of embodiments 1-64, wherein the lid and container are made from different material. Embodiment 66 comprises the circuit patch of any one of embodiments 1-65, wherein the bottom portion of the lid seals the open end of the container. Embodiment 67 comprises the circuit patch of any one of embodiments 1-66, wherein the bottom portion of the lid snaps on to the open of the container. Embodiment 68 comprises the circuit patch of any one of embodiments 1-67, wherein the container comprises at least one protruding latch on an outer surface of the container. Embodiment 69 comprises the circuit patch of any one of embodiments 1-68, wherein the container comprises a plurality of protruding latches. Embodiment 70 comprises the circuit patch of any one of embodiments 1-69, wherein the protruding latch latches onto a container holder to lock the container into place. Embodiment 71 comprises the circuit patch of any one of embodiments 1-70, wherein the protruding latch latches onto a container holder to place the electrically conductive in contact with an end portion of a spring-loaded contact on a lid heating printed circuit board (PCB) of the container holder. Embodiment 72 comprises the circuit patch of any one of embodiments 1-71, wherein heating of the lid prevents condensation and volume loss of the sample. Embodiment 73 comprises the circuit patch of any one of the embodiments, wherein the circuit patch has an opening. Embodiment 74 comprises the circuit patch of any one of the embodiments, wherein the circuit patch opening allows for viewing into the container below when the circuit patch is placed over the container. Embodiment 75 comprises the circuit patch of any one of the embodiments, wherein the circuit patch opening allows for imaging by the camera of the sample in the container when the circuit patch is placed over the container. Embodiment 76 comprises the circuit patch of any one of the embodiments, wherein imaging by the camera of the sample through the circuit patch opening provides information about the sample. Embodiment 77 comprises the circuit patch of any one of the embodiments, wherein the sample information is a concentration of a product of a reaction in the container. Embodiment 78 comprises the circuit patch of any one of the embodiments, wherein the thermocycler stops the thermocycling protocol for the container when the concentration of the product is above a threshold concentration. Embodiment 79 comprises the circuit patch of any one of the embodiments, wherein the sample information is a concentration of a reagent in the container. Embodiment 80 comprises the circuit patch of any one of the embodiments, wherein the thermocycler stops the thermocycling protocol for the container when the concentration of the reagent is below a threshold concentration.

Embodiment 81 comprises a heating lid for a container comprising: a lid having a top portion and a bottom portion, wherein the bottom portion is configured to close an open end of the container; and a circuit patch in contact with the lid. Embodiment 82 comprises the heating lid of any one of the embodiments, wherein the circuit patch comprises at least one of a heating element, an electrically conductive contact, or a temperature sensor, or a combination thereof. Embodiment 83 comprises the heating lid of any one of the embodiments, wherein the heating element comprise a resistive heating element. Embodiment 84 comprises the heating lid of any one of the embodiments, wherein the electrically conductive contact comprises an electrically conductive contact. Embodiment 85 comprises the heating lid of any one of the embodiments, wherein the circuit patch is placed on the top portion of the lid. Embodiment 86 comprises the heating lid of any one of the embodiments, wherein the circuit patch has an adhesive surface that is placed on the top portion of the lid. Embodiment 87 comprises the heating lid of any one of the embodiments, wherein the heating element is embedded in the circuit patch. Embodiment 88 comprises the heating lid of any one of the embodiments, wherein the heating element changes the temperature of the lid. Embodiment 89 comprises the heating lid of any one of the embodiments, wherein the heating element has a temperature range from 50□C to 110□C. Embodiment 90 comprises the heating lid of any one of the embodiments, wherein the circuit patch comprises at least two electrically conductive contact. Embodiment 91 comprises the heating lid of any one of the embodiments, wherein the electrically conductive contact is placed near the perimeter of the lid. Embodiment 92 comprises the heating lid of any one of the embodiments, wherein the electrically conductive contact is placed on top of a hole near the perimeter of the lid. Embodiment 93 comprises the heating lid of any one of the embodiments, wherein the hole is configured to fit an end portion of a spring-loaded contact on a lid heating printed circuit board (PCB) of a container holder when the container is placed in the container holder and the lid closes the open end of the container. Embodiment 94 comprises the heating lid of any one of the embodiments, wherein the spring-loaded contact has a diameter of no more than 0.5 mm. Embodiment 95 comprises the heating lid of any one of the embodiments, wherein the electrically conductive contact comes into contact with an end portion of a spring-loaded contact on a container holder when the container is placed in the container holder and the lid closes the open end of the container. Embodiment 96 comprises the heating lid of any one of the embodiments, wherein the electrically conductive contact is spaced apart from the heating element. Embodiment 97 comprises the heating lid of any one of the embodiments, wherein the electrically conductive contact is spaced from the heating element. Embodiment 98 comprises the heating lid of any one of the embodiments, wherein the temperature sensor comprises at least one of a thermistor, a thermocouple, a resistance temperature detector (RTD), or a thermochromic sensor, or a combination thereof. Embodiment 99 comprises the heating lid of any one of the embodiments, wherein the thermistor is a thin film thermistor. Embodiment 100 comprises the heating lid of any one of the embodiments, wherein the temperature sensor is capable of detecting a temperature range from 50□C to 110□C. Embodiment 101 comprises the heating lid of any one of the embodiments, wherein the thermochromic sensor is a printed layer of thermochromic ink. Embodiment 102 comprises the heating lid of any one of the embodiments, wherein the thermochromic sensor changes color as a temperature of the circuit patch changes. Embodiment 103 comprises the heating lid of any one of the embodiments, wherein the color change of the thermochromic sensor is captured by a camera. Embodiment 104 comprises the heating lid of any one of the embodiments, wherein the camera comprises a visible light camera. Embodiment 105 comprises the heating lid of any one of the embodiments, wherein the camera comprises an infrared camera. Embodiment 106 comprises the heating lid of any one of the embodiments, wherein a control system uses color change to check temperature of the lid heated by the heating element and makes changes to heating by the heating element as needed. Embodiment 107 comprises the heating lid of any one of the embodiments, wherein a control system uses a reading by the temperature sensor to control temperature of the heating element. Embodiment 108 comprises the heating lid of any one of the embodiments, wherein a control system uses temperature sensor to check temperature of the lid heated by the heating element and makes changes to heating by the heating element as needed. Embodiment 109 comprises the heating lid of any one of the embodiments, wherein the control system makes changes to heating by the heating element without user input. Embodiment 110 comprises the heating lid of any one of the embodiments, wherein the temperature sensor is placed on a top surface of the circuit patch. Embodiment 111 comprises the heating lid of any one of the embodiments, wherein the temperature sensor is placed on top of the heating element. Embodiment 112 comprises the heating lid of any one of the embodiments, wherein the temperature sensor is offset from the heating element and near a perimeter of the lid. Embodiment 113 comprises the heating lid of any one of the embodiments, wherein the circuit patch or the container comprises a unique marking. Embodiment 114 comprises the heating lid of any one of the embodiments, wherein the unique marking comprises a QR code. Embodiment 115 comprises the heating lid of any one of the embodiments, wherein the unique marking comprises an identification information. Embodiment 116 comprises the heating lid of any one of the embodiments, wherein the identification information comprises at least one of a sample information, a protocol information, or a temperature protocol information, or a combination thereof. Embodiment 117 comprises the heating lid of any one of the embodiments, wherein the unique marking is readable by a camera. Embodiment 118 comprises the heating lid of any one of the embodiments, wherein the circuit patch has a thickness of no more than 0.5 mm. Embodiment 119 comprises the heating lid of any one of the embodiments, wherein the circuit patch has a thickness of about 0.35 mm. Embodiment 120 comprises the heating lid of any one of the embodiments, wherein the lid comprises a plastic. Embodiment 121 comprises the heating lid of any one of the embodiments, wherein the plastic comprises at least one of polyethylene, polypropylene, or a combination thereof. Embodiment 122 comprises the heating lid of any one of the embodiments, wherein the lid made by injection molding. Embodiment 123 comprises the heating lid of any one of the embodiments, wherein the lid and the container are made from the same material. Embodiment 124 comprises the heating lid of any one of the embodiments, wherein the lid and container are made from different material. Embodiment 125 comprises the heating lid of any one of the embodiments, wherein the bottom portion of the lid seals the open end of the container. Embodiment 126 comprises the heating lid of any one of the embodiments, wherein the bottom portion of the lid snaps on to the open of the container. Embodiment 127 comprises the heating lid of any one of the embodiments, wherein the container comprises at least one protruding latch on an outer surface of the container. Embodiment 128 comprises the heating lid of any one of the embodiments, wherein the container comprises a plurality of protruding latches. Embodiment 129 comprises the heating lid of any one of the embodiments, wherein the protruding latch latches onto a container holder to lock the container into place. Embodiment 130 comprises the heating lid of any one of the embodiments, wherein the protruding latch latches onto a container holder to place the electrically conductive in contact with an end portion of a spring-loaded contact on a lid heating printed circuit board (PCB) of the container holder. Embodiment 131 comprises the heating lid of any one of the embodiments, wherein the lid is connected to another lid in a lid strip and the container is connected to another container in a container strip. Embodiment 132 comprises the heating lid of any one of the embodiments, wherein the lid is connected to another lid in a lid strip. Embodiment 133 comprises the heating lid of any one of the embodiments, wherein the lid strip comprises 4, 8, 12, 24, 48, 96, 128, 384, or 1536 lids. Embodiment 134 comprises the heating lid of any one of the embodiments, wherein the heating element of the lid in the lid strip is controlled independently from a heating element of a neighboring lid by a control system. Embodiment 135 comprises the heating lid of any one of the embodiments, wherein the container is connected to another container in a plurality of containers. Embodiment 136 comprises the heating lid of any one of the embodiments, wherein the plurality of containers comprises at least 4, 8, 12, 24, 48, 96, 128, 384, or 1536 containers. Embodiment 137 comprises the heating lid of any one of the embodiments, wherein the plurality of containers comprises 4, 8, 12, 24, 48, 96, 128, 384, or 1536 containers. Embodiment 138 comprises the heating lid of any one of the embodiments, wherein the plurality of containers is a multiwell plate. Embodiment 139 comprises the heating lid of any one of the embodiments, wherein the plurality of containers is consumable. Embodiment 140 comprises the heating lid of any one of the embodiments, the heating element of the lid in the lid strip is controlled independently from a heating element of a neighboring lid by a control system. Embodiment 141 comprises the heating lid of any one of the embodiments, wherein heating of the lid prevents condensation and volume loss of the sample.

Embodiment 142 comprises a sample vial for heating a sample comprising: a container having an open end; and a heating lid comprising i) a lid having a top portion and a bottom portion, wherein the bottom portion is configured to close the open end of the container, and ii) a circuit patch in contact with the lid. Embodiment 143 comprises the sample vial of embodiment 142, wherein the sample comprises a polynucleotide. Embodiment 144 comprises the sample vial of any one of the embodiments, wherein the sample vial is used on a thermocycler. Embodiment 145 comprises the sample vial of any one of the embodiments, wherein heating of the lid prevents condensation and volume loss of the sample. Embodiment 146 comprises the sample vial of any one of the embodiments, wherein the circuit patch comprises at least one of a heating element, an electrically conductive contact, or a temperature sensor, or a combination thereof. Embodiment 147 comprises the sample vial of any one of the embodiments, wherein the heating element comprise a resistive heating element. Embodiment 148 comprises the sample vial of any one of the embodiments, wherein the electrically conductive contact comprises an electrically conductive contact. Embodiment 149 comprises the sample vial of any one of the embodiments, wherein the circuit patch is placed on the top portion of the lid. Embodiment 150 comprises the sample vial of any one of the embodiments, wherein the circuit patch has an adhesive surface that is placed on the top portion of the lid. Embodiment 151 comprises the sample vial of any one of the embodiments, wherein the heating element is embedded in the circuit patch. Embodiment 152 comprises the sample vial of any one of the embodiments, wherein the heating element changes the temperature of the lid. Embodiment 153 comprises the sample vial of any one of the embodiments, wherein the heating element has a temperature range from 50 □C to 110 □C. Embodiment 154 comprises the sample vial of any one of the embodiments, wherein the circuit patch comprises at least two electrically conductive contact. Embodiment 155 comprises the sample vial of any one of the embodiments, wherein the electrically conductive contact is placed near the perimeter of the lid. Embodiment 156 comprises the sample vial of any one of the embodiments, wherein the electrically conductive contact is placed on top of a hole near the perimeter of the lid. Embodiment 157 comprises the sample vial of any one of the embodiments, wherein the hole is configured to fit an end portion of a spring-loaded contact on a lid heating printed circuit board (PCB) of a container holder when the container is placed in the container holder and the lid closes the open end of the container. Embodiment 158 comprises the sample vial of any one of the embodiments, wherein the electrically conductive contact comes into contact with an end portion of a spring-loaded contact on a container holder when the container is placed in the container holder and the lid closes the open end of the container. Embodiment 159 comprises the sample vial of any one of the embodiments, wherein the electrically conductive contact is spaced apart from the heating element. Embodiment 160 comprises the sample vial of any one of the embodiments, wherein the electrically conductive contact is spaced from the heating element. Embodiment 161 comprises the sample vial of any one of the embodiments, wherein the temperature sensor comprises at least one of a thermistor, a thermocouple, a resistance temperature detector (RTD), or a thermochromic sticker, or a combination thereof. Embodiment 162 comprises the sample vial of any one of the embodiments, wherein the thermistor is a thin film thermistor. Embodiment 163 comprises the sample vial of any one of the embodiments, wherein the temperature sensor is capable of detecting a temperature range from 50□C to 110□C. Embodiment 164 comprises the sample vial of any one of the embodiments, wherein the thermochromic sticker is capable of detecting a temperature range from 50□C to 110□C. Embodiment 165 comprises the sample vial of any one of the embodiments, wherein the thermochromic sticker changes color as a temperature of the circuit patch changes. Embodiment 166 comprises the sample vial of any one of the embodiments, wherein the color change of the thermochromic sticker is captured by a camera. Embodiment 167 comprises the sample vial of any one of the embodiments, wherein the camera comprises a visible light camera. Embodiment 168 comprises the sample vial of any one of the embodiments, wherein the camera comprises an infrared camera. Embodiment 169 comprises the sample vial of any one of the embodiments, wherein a control system uses color change to check temperature of the lid heated by the heating element and makes changes to heating by the heating element as needed. Embodiment 170 comprises the sample vial of any one of the embodiments, wherein a control system uses a reading by the temperature sensor to control temperature of the heating element. Embodiment 171 comprises the sample vial of any one of the embodiments, wherein a control system uses temperature sensor to check temperature of the lid heated by the heating element and makes changes to heating by the heating element as needed. Embodiment 172 comprises the sample vial of any one of the embodiments, wherein the control system makes changes to heating by the heating element without user input. Embodiment 173 comprises the sample vial of any one of the embodiments, wherein the temperature sensor is placed on a top surface of the circuit patch. Embodiment 174 comprises the sample vial of any one of the embodiments, wherein the temperature sensor is placed on top of the heating element. Embodiment 175 comprises the sample vial of any one of the embodiments, wherein the temperature sensor is offset from the heating element and near a perimeter of the lid. Embodiment 176 comprises the sample vial of any one of the embodiments, wherein the circuit patch or the container comprises a unique marking. Embodiment 177 comprises the sample vial of any one of the embodiments, wherein the unique marking comprises a QR code. Embodiment 178 comprises the sample vial of any one of the embodiments, wherein the unique marking comprises an identification information. Embodiment 179 comprises the sample vial of any one of the embodiments, wherein the identification information comprises at least one of a sample information, a protocol information, or a temperature protocol information, or a combination thereof. Embodiment 180 comprises the sample vial of any one of the embodiments, wherein the circuit patch has a thickness of no more than 0.5 mm. Embodiment 181 comprises the sample vial of any one of the embodiments, wherein the circuit patch has a thickness of about 0.35 mm. Embodiment 182 comprises the sample vial of any one of the embodiments, wherein the lid comprises a plastic. Embodiment 183 comprises the sample vial of any one of the embodiments, wherein the plastic comprises at least one of polyethylene, polypropylene, or a combination thereof. Embodiment 184 comprises the sample vial of any one of the embodiments, wherein the lid made by injection molding. Embodiment 185 comprises the sample vial of any one of the embodiments, wherein the lid and the container are made from the same material. Embodiment 186 comprises the sample vial of any one of the embodiments, wherein the lid and container are made from different material. Embodiment 187 comprises the sample vial of any one of the embodiments, wherein the bottom portion of the lid seals the open end of the container. Embodiment 188 comprises the sample vial of any one of the embodiments, wherein the bottom portion of the lid snaps on to the open of the container. Embodiment 189 comprises the sample vial of any one of the embodiments, wherein the container comprises at least one protruding latch on an outer surface of the container. Embodiment 190 comprises the sample vial of any one of the embodiments, wherein the container comprises a plurality of protruding latches. Embodiment 191 comprises the sample vial of any one of the embodiments, wherein the protruding latch latches onto a container holder to place the electrically conductive in contact with an end portion of a spring-loaded contact on a lid heating printed circuit board (PCB) of the container holder. Embodiment 192 comprises the sample vial of any one of the embodiments, wherein the container comprises a magnetic or electromagnetic securing element. Embodiment 193 comprises the sample vial of any one of the embodiments, wherein the lid is connected to another lid in a lid strip and the container is connected to another container in a container strip. Embodiment 194 comprises the sample vial of any one of the embodiments, wherein the lid is connected to another lid in a lid strip. Embodiment 195 comprises the sample vial of any one of the embodiments, wherein the lid strip comprises 4, 8, 12, 24, 48, 96, 128, 384, or 1536 lids. Embodiment 196 comprises the sample vial of any one of the embodiments, wherein the heating element of the lid in the lid strip is controlled independently from a heating element of a neighboring lid by a control system. Embodiment 197 comprises the sample vial of any one of the embodiments, wherein the container is connected to another container in a plurality of containers. Embodiment 198 comprises the sample vial of any one of the embodiments, wherein the plurality of containers comprises at least 4, 8, 12, 24, 48, 96, 128, 384, or 1536 containers. Embodiment 199 comprises the sample vial of any one of the embodiments, wherein the plurality of containers comprises 4, 8, 12, 24, 48, 96, 128, 384, or 1536 containers. Embodiment 200 comprises the sample vial of any one of the embodiments, wherein the plurality of containers is a multiwell plate. Embodiment 201 comprises the sample vial of any one of the embodiments, wherein the plurality of containers is consumable. Embodiment 202 comprises the sample vial of any one of the embodiments, wherein the heating element of the lid in the lid strip is controlled independently from a heating element of a neighboring lid by a control system. Embodiment 203 comprises the sample vial of any one of the embodiments, wherein heating of the lid prevents condensation and volume loss of the sample. Embodiment 204 comprises the sample vial of any one of the embodiments, wherein the heating element of the lid in the lid strip is controlled independently from a heating element of a neighboring lid by a control system.

Embodiment 205 comprises a system for independent thermocycling for polynucleotide synthesis comprising: a) a plurality of sample vials, wherein a sample vial comprising a container having an open end and a heating lid comprising i) a lid having a top portion and a bottom portion, wherein the bottom portion is configured to close the open end of the container, and ii) a circuit patch in contact with the lid; a vial holder; b) a control system; and c) a camera. Embodiment 206 comprises the system of any one of the embodiments, wherein the heating element of the sample vial is independently controlled by the control system. Embodiment 207 comprises the system of any one of the embodiments, wherein the camera comprises a visible light camera. Embodiment 208 comprises the system of any one of the embodiments, wherein the camera comprises an infrared camera. Embodiment 209 comprises the system of any one of the embodiments, wherein the camera is capable of capturing the plurality of sample vials in a single image. Embodiment 210 comprises the system of any one of the embodiments, wherein the camera continually captures images of the plurality of sample vials. Embodiment 211 comprises the system of any one of the embodiments, wherein the plurality of sample vials comprises at least 96 sample vials. Embodiment 212 comprises the system of any one of the embodiments, wherein the vial holder comprises at least 96 openings, wherein each opening is configured to hold a sample vial. Embodiment 213 comprises the system of any one of the embodiments, wherein a temperature of one vial holder opening is controlled independently from a temperature of another vial holder opening. Embodiment 214 comprises the system of any one of the embodiments, wherein the sample comprises a polynucleotide. Embodiment 215 comprises the system of any one of the embodiments, wherein the sample vial is used on a thermocycler. Embodiment 216 comprises the system of any one of the embodiments, wherein heating of the lid prevents condensation and volume loss of the sample. Embodiment 217 comprises the system of any one of the embodiments, wherein the circuit patch comprises at least one of a heating element, an electrically conductive contact, or a temperature sensor, or a combination thereof. Embodiment 218 comprises the system of any one of the embodiments, wherein the heating element comprise a resistive heating element. Embodiment 219 comprises the system of any one of the embodiments, wherein the electrically conductive contact comprises an electrically conductive contact. Embodiment 220 comprises the system of any one of the embodiments, wherein the circuit patch is placed on the top portion of the lid. Embodiment 221 comprises the system of any one of the embodiments, wherein the circuit patch has an adhesive surface that is placed on the top portion of the lid. Embodiment 222 comprises the system of any one of the embodiments, wherein the heating element is embedded in the circuit patch. Embodiment 223 comprises the system of any one of the embodiments, wherein the heating element changes the temperature of the lid. Embodiment 224 comprises the system of any one of the embodiments, wherein the heating element has a temperature range from 50□C to 110 □C. Embodiment 225 comprises the system of any one of the embodiments, wherein the circuit patch comprises at least two electrically conductive contact. Embodiment 226 comprises the system of any one of the embodiments, wherein the electrically conductive contact is placed near the perimeter of the lid. Embodiment 227 comprises the system of any one of the embodiments, wherein the electrically conductive contact is placed on top of a hole near the perimeter of the lid. Embodiment 228 comprises the system of any one of the embodiments, wherein the hole is configured to fit an end portion of a spring-loaded contact on a lid heating printed circuit board (PCB) of a container holder when the container is placed in the container holder and the lid closes the open end of the container. Embodiment 229 comprises the system of any one of the embodiments, wherein the electrically conductive contact comes into contact with an end portion of a spring-loaded contact on a container holder when the container is placed in the container holder and the lid closes the open end of the container. Embodiment 230 comprises the system of any one of the embodiments, wherein the electrically conductive contact is spaced apart from the heating element. Embodiment 231 comprises the system of any one of the embodiments, wherein the electrically conductive contact is spaced from the heating element. Embodiment 232 comprises the system of any one of the embodiments, wherein the temperature sensor comprises at least one of a thermistor, a thermocouple, a resistance temperature detector (RTD), or a thermochromic sticker, or a combination thereof. Embodiment 233 comprises the system of any one of the embodiments, wherein the thermistor is a thin film thermistor. Embodiment 234 comprises the system of any one of the embodiments, wherein the temperature sensor is capable of detecting a temperature range from 50 □C to 110 □C. Embodiment 235 comprises the system of any one of the embodiments, wherein the thermochromic sticker is capable of detecting a temperature range from 50□C to 110 □C. Embodiment 236 comprises the system of any one of the embodiments, wherein the thermochromic sticker changes color as a temperature of the circuit patch changes. Embodiment 237 comprises the system of any one of the embodiments, wherein the color change of the thermochromic sticker is captured by a camera. Embodiment 238 comprises the system of any one of the embodiments, wherein a control system uses color change to check temperature of the lid heated by the heating element and makes changes to heating by the heating element as needed. Embodiment 239 comprises the system of any one of the embodiments, wherein a control system uses a reading by the temperature sensor to control temperature of the heating element. Embodiment 240 comprises the system of any one of the embodiments, wherein a control system uses temperature sensor to check temperature of the lid heated by the heating element and makes changes to heating by the heating element as needed. Embodiment 241 comprises the system of any one of the embodiments, wherein the control system makes changes to heating by the heating element without user input. Embodiment 242 comprises the system of any one of the embodiments, wherein the temperature sensor is placed on a top surface of the circuit patch. Embodiment 243 comprises the system of any one of the embodiments, wherein the temperature sensor is placed on top of the heating element. Embodiment 244 comprises the system of any one of the embodiments, wherein the temperature sensor is offset from the heating element and near a perimeter of the lid. Embodiment 245 comprises the system of any one of the embodiments, wherein the circuit patch or the container comprises a unique marking. Embodiment 246 comprises the system of any one of the embodiments, wherein the unique marking comprises a QR code. Embodiment 247 comprises the system of any one of the embodiments, wherein the unique marking comprises an identification information. Embodiment 248 comprises the system of any one of the embodiments, wherein the identification information comprises at least one of a sample information, a protocol information, or a temperature protocol information, or a combination thereof. Embodiment 249 comprises the system of any one of the embodiments, wherein the circuit patch has a thickness of no more than 0.5 mm. Embodiment 250 comprises the system of any one of the embodiments, wherein the circuit patch has a thickness of about 0.35 mm. Embodiment 251 comprises the system of any one of the embodiments, wherein the lid comprises a plastic. Embodiment 252 comprises the system of any one of the embodiments, wherein the plastic comprises at least one of polyethylene, polypropylene, or a combination thereof. Embodiment 253 comprises the system of any one of the embodiments, wherein the lid made by injection molding. Embodiment 254 comprises the system of any one of the embodiments, wherein the lid and the container are made from the same material. Embodiment 255 comprises the system of any one of the embodiments, wherein the lid and container are made from different material. Embodiment 256 comprises the system of any one of the embodiments, wherein the bottom portion of the lid seals the open end of the container. Embodiment 257 comprises the system of any one of the embodiments, wherein the bottom portion of the lid snaps on to the open of the container. Embodiment 258 comprises the system of any one of the embodiments, wherein the container comprises at least one protruding latch on an outer surface of the container. Embodiment 259 comprises the system of any one of the embodiments, wherein the container comprises a plurality of protruding latches. Embodiment 260 comprises the system of any one of the embodiments, wherein the protruding latch latches onto a container holder to place the electrically conductive in contact with an end portion of a spring-loaded contact on a lid heating printed circuit board (PCB) of the container holder. Embodiment 261 comprises the system of any one of the embodiments, wherein the lid is connected to another lid in a lid strip and the container is connected to another container in a container strip. Embodiment 262 comprises the system of any one of the embodiments, wherein the lid is connected to another lid in a lid strip. Embodiment 263 comprises the system of any one of the embodiments, wherein the lid strip comprises 4, 8, 12, 24, 48, 96, 128, 384, or 1536 lids. Embodiment 264 comprises the system of any one of the embodiments, wherein the heating element of the lid in the lid strip is controlled independently from a heating element of a neighboring lid by a control system. Embodiment 265 comprises the system of any one of the embodiments, wherein the container is connected to another container in a plurality of containers. Embodiment 266 comprises the system of any one of the embodiments, wherein the plurality of containers comprises at least 4, 8, 12, 24, 48, 96, 128, 384, or 1536 containers. Embodiment 267 comprises the system of any one of the embodiments, wherein the plurality of containers comprises 4, 8, 12, 24, 48, 96, 128, 384, or 1536 containers. Embodiment 268 comprises the system of any one of the embodiments, wherein the plurality of containers is a multiwell plate. Embodiment 269 comprises the system of any one of the embodiments, wherein the plurality of containers is consumable. Embodiment 270 comprises the system of any one of the embodiments, wherein the heating element of the lid in the lid strip is controlled independently from a heating element of a neighboring lid by a control system. Embodiment 271 comprises the system of any one of the embodiments, wherein heating of the lid prevents condensation and volume loss of the sample. Embodiment 272 comprises the system of any one of the embodiments, wherein the heating element of the lid in the lid strip is controlled independently from a heating element of a neighboring lid by a control system.

Embodiment 273 comprises a method of independent thermocycling for polynucleotide synthesis comprising: (a) loading a sample into a sample vial comprising i) a container having an open end and ii) a circuit patch in contact with the lid, wherein the circuit patch comprises a heating element, an electrically conductive contact, and a temperature sensor; (b) placing the sample vial holding the sample into a container holder of a thermocycler; and (c) running a thermocycling protocol on the sample vial, wherein running comprises continually reading a temperature of the lid by the temperature sensor and adjusting the temperature provided by the heating element as needed. Embodiment 274 comprises the method of any of the embodiments, wherein running a thermocycling protocol on the sample vial further comprises using a camera to detect an identification marking on the lid, matching the detected identification marking with a thermocycling protocol from a database in communication with the thermocycler, assigning the matched thermocycling protocol to the sample vial, and changing the temperature provided by the heating element based the matched thermocycling protocol. Embodiment 275 comprises the method of any of the embodiments, wherein the temperature provided by the heating element changed based on matched thermocycling protocol and the temperature of the lid read by the temperature sensor. Embodiment 276 comprises the method of any of the embodiments, wherein the database is in communication with the thermocycler. Embodiment 277 comprises the method of any of the embodiments, wherein running thermocycling protocol is performed without user input. Embodiment 278 comprises the method of any of the embodiments, wherein running thermocycling protocol is performed automatically after the sample vial is placed into the container holder. Embodiment 279 comprises the method of any of the embodiments, wherein adjusting the temperature provided by the heating element is performed by a control system without user input. Embodiment 280 comprises the method of any of the embodiments, wherein the sample comprises a polynucleotide. Embodiment 281 comprises the method of any one of the embodiments, wherein heating of the lid prevents condensation and volume loss of the sample. Embodiment 282 comprises the method of any one of the embodiments, wherein the circuit patch comprises at least one of a heating element, an electrically conductive contact, or a temperature sensor, or a combination thereof. Embodiment 283 comprises the method of any one of the embodiments, wherein the heating element comprise a resistive heating element. Embodiment 284 comprises the method of any one of the embodiments, wherein the electrically conductive contact comprises an electrically conductive contact. Embodiment 285 comprises the method of any one of the embodiments, wherein the circuit patch is placed on the top portion of the lid. Embodiment 286 comprises the method of any one of the embodiments, wherein the circuit patch has an adhesive surface that is placed on the top portion of the lid. Embodiment 287 comprises the method of any one of the embodiments, wherein the heating element is embedded in the circuit patch. Embodiment 288 comprises the method of any one of the embodiments, wherein the heating element changes the temperature of the lid. Embodiment 289 comprises the method of any one of the embodiments, wherein the heating element has a temperature range from 50□C to 110□C. Embodiment 290 comprises the method of any one of the embodiments, wherein the circuit patch comprises at least two electrically conductive contact. Embodiment 291 comprises the method of any one of the embodiments, wherein the electrically conductive contact is placed near the perimeter of the lid. Embodiment 292 comprises the method of any one of the embodiments, wherein the electrically conductive contact is placed on top of a hole near the perimeter of the lid. Embodiment 293 comprises the method of any one of the embodiments, wherein the hole is configured to fit an end portion of a spring-loaded contact on a lid heating printed circuit board (PCB) of a container holder when the container is placed in the container holder and the lid closes the open end of the container. Embodiment 294 comprises the method of any one of the embodiments, wherein the electrically conductive contact comes into contact with an end portion of a spring-loaded contact on a container holder when the container is placed in the container holder and the lid closes the open end of the container. Embodiment 295 comprises the method of any one of the embodiments, wherein the electrically conductive contact is spaced apart from the heating element. Embodiment 296 comprises the method of any one of the embodiments, wherein the electrically conductive contact is spaced from the heating element. Embodiment 297 comprises the method of any one of the embodiments, wherein the temperature sensor comprises at least one of a thermistor, a thermocouple, a resistance temperature detector (RTD), or a thermochromic sticker, or a combination thereof. Embodiment 298 comprises the method of any one of the embodiments, wherein the thermistor is a thin film thermistor. Embodiment 299 comprises the method of any one of the embodiments, wherein the temperature sensor is capable of detecting a temperature range from 50 □C to 110 □C. Embodiment 300 comprises the method of any one of the embodiments, wherein the thermochromic sticker is capable of detecting a temperature range from 50 □C to 110 □C. Embodiment 301 comprises the method of any one of the embodiments, wherein the thermochromic sticker changes color as a temperature of the circuit patch changes. Embodiment 302 comprises the method of any one of the embodiments, wherein the color change of the thermochromic sticker is captured by a camera. Embodiment 303 comprises the method of any one of the embodiments, wherein the camera comprises a visible light camera. Embodiment 304 comprises the method of any one of the embodiments, wherein the camera comprises an infrared camera. Embodiment 305 comprises the method of any one of the embodiments, wherein a control system uses color change to check temperature of the lid heated by the heating element and makes changes to heating by the heating element as needed. Embodiment 306 comprises the method of any one of the embodiments, wherein a control system uses a reading by the temperature sensor to control temperature of the heating element. Embodiment 307 comprises the method of any one of the embodiments, wherein a control system uses temperature sensor to check temperature of the lid heated by the heating element and makes changes to heating by the heating element as needed. Embodiment 308 comprises the method of any one of the embodiments, wherein the control system makes changes to heating by the heating element without user input. Embodiment 309 comprises the method of any one of the embodiments, wherein the temperature sensor is placed on a top surface of the circuit patch. Embodiment 310 comprises the method of any one of the embodiments, wherein the temperature sensor is placed on top of the heating element. Embodiment 311 comprises the method of any one of the embodiments, wherein the temperature sensor is offset from the heating element and near a perimeter of the lid. Embodiment 312 comprises the method of any one of the embodiments, wherein the circuit patch or the container comprises a unique marking. Embodiment 313 comprises the method of any one of the embodiments, wherein the unique marking comprises a QR code. Embodiment 314 comprises the method of any one of the embodiments, wherein the unique marking comprises an identification information. Embodiment 315 comprises the method of any one of the embodiments, wherein the identification information comprises at least one of a sample information, a protocol information, or a temperature protocol information, or a combination thereof. Embodiment 316 comprises the method of any one of the embodiments, wherein the circuit patch has a thickness of no more than 0.5 mm. Embodiment 317 comprises the method of any one of the embodiments, wherein the circuit patch has a thickness of about 0.35 mm. Embodiment 318 comprises the method of any one of the embodiments, wherein the lid comprises a plastic. Embodiment 319 comprises the method of any one of the embodiments, wherein the plastic comprises at least one of polyethylene, polypropylene, or a combination thereof. Embodiment 320 comprises the method of any one of the embodiments, wherein the lid made by injection molding. Embodiment 321 comprises the method of any one of the embodiments, wherein the lid and the container are made from the same material. Embodiment 322 comprises the method of any one of the embodiments, wherein the lid and container are made from different material. Embodiment 323 comprises the method of any one of the embodiments, wherein the bottom portion of the lid seals the open end of the container. Embodiment 324 comprises the method of any one of the embodiments, wherein the bottom portion of the lid snaps on to the open of the container. Embodiment 325 comprises the method of any one of the embodiments, wherein the container comprises at least one protruding latch on an outer surface of the container. Embodiment 326 comprises the method of any one of the embodiments, wherein the container comprises a plurality of protruding latches. Embodiment 327 comprises the method of any one of the embodiments, wherein the protruding latch latches onto a container holder to place the electrically conductive in contact with an end portion of a spring-loaded contact on a lid heating printed circuit board (PCB) of the container holder. Embodiment 328 comprises the method of any one of the embodiments, wherein the lid is connected to another lid in a lid strip and the container is connected to another container in a container strip. Embodiment 329 comprises the method of any one of the embodiments, wherein the lid is connected to another lid in a lid strip. Embodiment 330 comprises the method of any one of the embodiments, wherein the lid strip comprises 4, 8, 12, 24, 48, 96, 128, 384, or 1536 lids. Embodiment 331 comprises the method of any one of the embodiments, wherein the heating element of the lid in the lid strip is controlled independently from a heating element of a neighboring lid by a control system. Embodiment 332 comprises the method of any one of the embodiments, wherein the container is connected to another container in a plurality of containers. Embodiment 333 comprises the method of any one of the embodiments, wherein the plurality of containers comprises at least 4, 8, 12, 24, 48, 96, 128, 384, or 1536 containers. Embodiment 334 comprises the method of any one of the embodiments, wherein the plurality of containers comprises 4, 8, 12, 24, 48, 96, 128, 384, or 1536 containers. Embodiment 335 comprises the method of any one of the embodiments, wherein the plurality of containers is a multiwell plate. Embodiment 336 comprises the method of any one of the embodiments, wherein the plurality of containers is consumable. Embodiment 337 comprises the method of any one of the embodiments, wherein the heating element of the lid in the lid strip is controlled independently from a heating element of a neighboring lid by a control system. Embodiment 338 comprises the method of any one of the embodiments, wherein heating of the lid prevents condensation and volume loss of the sample. Embodiment 339 comprises the method of any one of the embodiments, wherein the heating element of the lid in the lid strip is controlled independently from a heating element of a neighboring lid by a control system. Embodiment 340 comprises the method of any one of the embodiments, wherein the circuit patch has an opening. Embodiment 341 comprises the method of any one of the embodiments, wherein the circuit patch opening allows for viewing into the container below when the circuit patch is placed over the container. Embodiment 342 comprises the method of any one of the embodiments, wherein the circuit patch opening allows for imaging by the camera of the sample in the container when the circuit patch is placed over the container. Embodiment 343 comprises the method of any one of the embodiments, wherein imaging by the camera of the sample through the circuit patch opening provides information about the sample. Embodiment 344 comprises the method of any one of the embodiments, wherein the sample information is a concentration of a product of a reaction in the container. Embodiment 345 comprises the method of any one of the embodiments, wherein the thermocycler stops the thermocycling protocol for the container when the concentration of the product is above a threshold concentration. Embodiment 346 comprises the method of any one of the embodiments, wherein the sample information is a concentration of a reagent in the container. Embodiment 347 comprises the method of any one of the embodiments, wherein the thermocycler stops the thermocycling protocol for the container when the concentration of the reagent is below a threshold concentration.

Embodiment 348 comprises a sensor assembly for a sensor plate assembly, the sensor assembly comprising: a ring-shaped element having an inner perimeter, and a sensor holder having a sensor pad. Embodiment 349 comprises the sensor assembly of any one of the embodiments, wherein the sensor assembly is fabricated as a single piece. Embodiment 350 comprises the sensor assembly of any one of the embodiments, wherein the sensor assembly is fabricated by a die and roll form process. Embodiment 351 comprises the sensor assembly of any one of the embodiments, wherein the sensor assembly is fabricated by a coining process. Embodiment 352 comprises the sensor assembly of any one of the embodiments, wherein the sensor holder holds a sensor in place. Embodiment 353 comprises the sensor assembly of any one of the embodiments, wherein the sensor is a thermistor. Embodiment 354 comprises the sensor assembly of any one of the embodiments, wherein the sensor holder is connected to the ring-shaped portion along the inner perimeter of the ring-shaped portion. Embodiment 355 comprises the sensor assembly of any one of the embodiments, wherein the sensor holder extends upwards from the ring-shaped portion. Embodiment 356 comprises the sensor assembly of any one of the embodiments, wherein the ring-shaped element surrounds an opening in the sensor plate assembly, wherein the opening is configured to hold a container holder. Embodiment 357 comprises the sensor assembly of any one of the embodiments, wherein the ring-shaped element has a flat bottom surface. Embodiment 358 comprises the sensor assembly of any one of the embodiments, wherein the sensor assembly comprises at least two sensor holders that are evenly spaced apart. Embodiment 359 comprises the sensor assembly of any one of the embodiments, wherein the sensor assembly comprises at least two sensor pads that are evenly spaced apart. Embodiment 360 comprises the sensor assembly of any one of the embodiments, wherein the sensor holder comprises a housing having an opening and a wall. Embodiment 361 comprises the sensor assembly of any one of the embodiments, wherein the housing comprises a tube. Embodiment 362 comprises the sensor assembly of any one of the embodiments, wherein the housing comprises a tapered tube. Embodiment 363 comprises the sensor assembly of any one of the embodiments, wherein the wall of the housing is at an angle of no more than 90 degrees relative to a centerline of the ring-shaped element. Embodiment 364 comprises the sensor assembly of any one of the embodiments, wherein the wall of the housing tilts inward toward the center of the ring-shaped element. Embodiment 365 comprises the sensor assembly of any one of the embodiments, wherein the housing holds a thermistor and the opening is configured for at least one sensor wire to extend out from the sensor holder. Embodiment 366 comprises the sensor assembly of any one of the embodiments, wherein the sensor wire connects the thermistor to the sensor plate assembly. Embodiment 367 comprises the sensor assembly of any one of the embodiments, wherein the sensor wire is soldered onto a circuit board for the sensor plate assembly. Embodiment 368 comprises the sensor assembly of any one of the embodiments, wherein the circuit board is a printed circuit board (PCB). Embodiment 369 comprises the sensor assembly of any one of the embodiments, wherein the sensor pad extends from the housing of the sensor holder and contacts an outer surface of a container holder. Embodiment 370 comprises the sensor assembly of any one of the embodiments, wherein the sensor pad provides for a large surface area for thermal transfer between the container holder and the sensor holder, wherein the large surface area improves the efficiency and accuracy of the thermal transfer. Embodiment 371 comprises the sensor assembly of any one of the embodiments, wherein the sensor pad provides for a large surface area for thermal transfer between the container holder and the sensor holder, wherein the large surface area improves the efficiency and accuracy of the thermal transfer. Embodiment 372 comprises the sensor assembly of any one of the embodiments, wherein the sensor pad comprises a spring-loaded portion configured to contact the outer surface of the container holder. Embodiment 373 comprises the sensor assembly of any one of the embodiments, wherein the sensor pad applies pressure to the outer surface of the container holder when the container holder placed in the ring-shaped element, wherein the pressure helps to keep the sensor pad in contact with the outer surface. Embodiment 374 comprises the sensor assembly of any one of the embodiments, wherein the sensor pad comprises a material having flexibility and memory. Embodiment 375 comprises the sensor assembly of any one of the embodiments, wherein the sensor pad comprises a material having a low elastic modulus. Embodiment 376 comprises the sensor assembly of any one of the embodiments, wherein the sensor pad comprises a material having an appropriate elongation. Embodiment 377 comprises the sensor assembly of any one of the embodiments, wherein the sensor pad has a height of at least 1 mm and a length of at least 1 mm. Embodiment 378 comprises the sensor assembly of any one of the embodiments, wherein the sensor holder is connected to the ring-shaped element perpendicularly. Embodiment 379 comprises the sensor assembly of any one of the embodiments, wherein the sensor holder is connected to the ring-shaped element at an angle no more than 90 degrees relative to an inner perimeter of the ring-shaped element. Embodiment 380 comprises the sensor assembly of any one of the embodiments, wherein the sensor pad is perpendicular to the ring-shaped element. Embodiment 381 comprises the sensor assembly of any one of the embodiments, wherein the sensor pad is at an angle no more than 90 degrees relative to an inner perimeter of the ring-shaped element. Embodiment 382 comprises the sensor assembly of any one of the embodiments, wherein the sensor assembly further comprises a support rib. Embodiment 383 comprises the sensor assembly of any one of the embodiments, wherein the support rib is connected to the ring-shaped portion along the inner perimeter of the ring-shaped portion. Embodiment 384 comprises the sensor assembly of any one of the embodiments, wherein the support rib extends upwards from the ring-shaped portion. Embodiment 385 comprises the sensor assembly of any one of the embodiments, wherein the support rib extends from the ring-shaped portion in same direction as the sensor holder. Embodiment 386 comprises the sensor assembly of any one of the embodiments, wherein the support rib provides anti-distortion support. Embodiment 387 comprises the sensor assembly of any one of the embodiments, wherein the support rib provides a spring-loaded support to position a container holder. Embodiment 388 comprises the sensor assembly of any one of the embodiments, wherein the sensor assembly comprises at least two support rib that are evenly spaced apart. Embodiment 389 comprises the sensor assembly of any one of the embodiments, wherein the sensor assembly comprises a material with high thermal conductivity. Embodiment 390 comprises the sensor assembly of any one of the embodiments, wherein the material comprises at least one of copper, tin, or phosphor bronze, or a combination thereof. Embodiment 391 comprises the sensor assembly of any one of the embodiments, wherein the material comprises a copper alloy. Embodiment 392 comprises the sensor assembly of any one of the embodiments, wherein the material comprises copper beryllium. Embodiment 393 comprises the sensor assembly of any one of the embodiments, wherein the material has thermal conductivity greater than 100 W/m*K. Embodiment 394 comprises the sensor assembly of any one of the embodiments, wherein the material has thermal conductivity greater than 200 W/m*K. Embodiment 395 comprises the sensor assembly of any one of the embodiments, wherein the sensor assembly further comprises at least two plate securing elements connected to the ring-shaped element. Embodiment 396 comprises the sensor assembly of any one of the embodiments, wherein the plate securing elements connect to an outer perimeter of the ring-shaped element. Embodiment 397 comprises the sensor assembly of any one of the embodiments, wherein the plate securing elements extend downward from the ring-shaped element. Embodiment 398 comprises the sensor assembly of any one of the embodiments, wherein the plate securing elements extend from the ring-shaped element in opposite direction as the sensor holder. Embodiment 399 comprises the sensor assembly of any one of the embodiments, wherein the plate securing elements are connected to the ring-shaped element at about 90 degrees relative to the ring-shaped element. Embodiment 400 comprises the sensor assembly of any one of the embodiments, wherein the plate securing elements have a width of at least 1 mm and a length of at least 2 mm. Embodiment 401 comprises the sensor assembly of any one of the embodiments, wherein the plate securing elements fit into securing holes in the sensor plate assembly to secure the sensor assembly onto the sensor plate assembly. Embodiment 402 comprises the sensor assembly of any one of the embodiments, wherein the plate securing elements are sized to have a smaller width than the securing holes. Embodiment 403 comprises the sensor assembly of any one of the embodiments, wherein design of the sensor assembly reduces assembly error in placing the sensor assembly on the sensor plate assembly.

Embodiment 404 comprises a sensor plate assembly for thermocycling comprising: a) a plurality of sensor assemblies, a sensor assembly comprising: a ring-shaped element having an inner perimeter, and a sensor holder having a sensor pad; b) a plurality of openings for container holders; c) a plurality of openings for securing sensor assemblies; d) a plurality of holes for sensor wires; and e) a circuit board for the sensor plate assembly. Embodiment 405 comprises the sensor plate assembly of any one of the embodiments, wherein the sensor assembly is fabricated as a single piece. Embodiment 406 comprises the sensor plate assembly of any one of the embodiments, wherein the sensor assembly is fabricated by a die and roll form process. Embodiment 407 comprises the sensor plate assembly of any one of the embodiments, wherein the sensor assembly is fabricated by a coining process. Embodiment 408 comprises the sensor plate assembly of any one of the embodiments, wherein the sensor holder holds a sensor in place. Embodiment 409 comprises the sensor plate assembly of any one of the embodiments, wherein the sensor is a thermistor. Embodiment 410 comprises the sensor plate assembly of any one of the embodiments, wherein the sensor holder is connected to the ring-shaped portion along the inner perimeter of the ring-shaped portion. Embodiment 411 comprises the sensor plate assembly of any one of the embodiments, wherein the sensor holder extends upwards from the ring-shaped portion. Embodiment 412 comprises the sensor plate assembly of any one of the embodiments, wherein the ring-shaped element surrounds an opening in the sensor plate assembly, wherein the opening is configured to hold a container holder. Embodiment 413 comprises the sensor plate assembly of any one of the embodiments, wherein the ring-shaped element has a flat bottom surface. Embodiment 414 comprises the sensor plate assembly of any one of the embodiments, wherein the sensor assembly comprises at least two sensor holders that are evenly spaced apart. Embodiment 415 comprises the sensor plate assembly of any one of the embodiments, wherein the sensor assembly comprises at least two sensor pads that are evenly spaced apart. Embodiment 416 comprises the sensor plate assembly of any one of the embodiments, wherein the sensor holder comprises a housing having an opening and a wall. Embodiment 417 comprises the sensor plate assembly of any one of the embodiments, wherein the housing comprises a tube. Embodiment 418 comprises the sensor plate assembly of any one of the embodiments, wherein the housing comprises a tapered tube. Embodiment 419 comprises the sensor plate assembly of any one of the embodiments, wherein the wall of the housing is at an angle of no more than 90 degrees relative to a centerline of the ring-shaped element. Embodiment 420 comprises the sensor plate assembly of any one of the embodiments, wherein the wall of the housing tilts inward toward the center of the ring-shaped element. Embodiment 421 comprises the sensor plate assembly of any one of the embodiments, wherein the housing holds a thermistor and the opening is configured for at least one sensor wire to extend out from the sensor holder. Embodiment 422 comprises the sensor plate assembly of any one of the embodiments, wherein the sensor wire connects the thermistor to the sensor plate assembly. Embodiment 423 comprises the sensor plate assembly of any one of the embodiments, wherein the sensor wire is soldered onto a circuit board for the sensor plate assembly. Embodiment 424 comprises the sensor plate assembly of any one of the embodiments, wherein the circuit board is a printed circuit board (PCB). Embodiment 425 comprises the sensor plate assembly of any one of the embodiments, wherein the sensor pad extends from the housing of the sensor holder and contacts an outer surface of a container holder. Embodiment 426 comprises the sensor plate assembly of any one of the embodiments, wherein the sensor pad provides for a large surface area for thermal transfer between the container holder and the sensor holder, wherein the large surface area improves the efficiency and accuracy of the thermal transfer. Embodiment 427 comprises the sensor plate assembly of any one of the embodiments, wherein the sensor pad provides for a large surface area for thermal transfer between the container holder and the sensor holder, wherein the large surface area improves the efficiency and accuracy of the thermal transfer. Embodiment 428 comprises the sensor plate assembly of any one of the embodiments, wherein the sensor pad comprises a spring-loaded portion configured to contact the outer surface of the container holder. Embodiment 429 comprises the sensor plate assembly of any one of the embodiments, wherein the sensor pad applies pressure to the outer surface of the container holder when the container holder placed in the ring-shaped element, wherein the pressure helps to keep the sensor pad in contact with the outer surface. Embodiment 430 comprises the sensor plate assembly of any one of the embodiments, wherein the sensor pad comprises a material having flexibility and memory. Embodiment 431 comprises the sensor plate assembly of any one of the embodiments, wherein the sensor pad comprises a material having a low elastic modulus. Embodiment 432 comprises the sensor plate assembly of any one of the embodiments, wherein the sensor pad comprises a material having an appropriate elongation. Embodiment 433 comprises the sensor plate assembly of any one of the embodiments, wherein the sensor pad has a height of at least 1 mm and a length of at least 1 mm. Embodiment 434 comprises the sensor plate assembly of any one of the embodiments, wherein the sensor holder is connected to the ring-shaped element perpendicularly. Embodiment 435 comprises the sensor plate assembly of any one of the embodiments, wherein the sensor holder is connected to the ring-shaped element at an angle no more than 90 degrees relative to an inner perimeter of the ring-shaped element. Embodiment 436 comprises the sensor plate assembly of any one of the embodiments, wherein the sensor pad is perpendicular to the ring-shaped element. Embodiment 437 comprises the sensor plate assembly of any one of the embodiments, wherein the sensor pad is at an angle no more than 90 degrees relative to an inner perimeter of the ring-shaped element. Embodiment 438 comprises the sensor plate assembly of any one of the embodiments, wherein the sensor assembly further comprises a support rib. Embodiment 439 comprises the sensor plate assembly of any one of the embodiments, wherein the support rib is connected to the ring-shaped portion along the inner perimeter of the ring-shaped portion. Embodiment 440 comprises the sensor plate assembly of any one of the embodiments, wherein the support rib extends upwards from the ring-shaped portion. Embodiment 441 comprises the sensor plate assembly of any one of the embodiments, wherein the support rib extends from the ring-shaped portion in same direction as the sensor holder. Embodiment 442 comprises the sensor plate assembly of any one of the embodiments, wherein the support rib provides anti-distortion support. Embodiment 443 comprises the sensor plate assembly of any one of the embodiments, wherein the support rib provides a spring-loaded support to position a container holder. Embodiment 444 comprises the sensor plate assembly of any one of the embodiments, wherein the sensor assembly comprises at least two support rib that are evenly spaced apart. Embodiment 445 comprises the sensor plate assembly of any one of the embodiments, wherein the sensor assembly comprises a material with high thermal conductivity. Embodiment 446 comprises the sensor plate assembly of any one of the embodiments, wherein the material comprises at least one of copper, tin, or phosphor bronze, or a combination thereof. Embodiment 447 comprises the sensor plate assembly of any one of the embodiments, wherein the material comprises a copper alloy. Embodiment 448 comprises the sensor plate assembly of any one of the embodiments, wherein the material comprises copper beryllium. Embodiment 449 comprises the sensor plate assembly of any one of the embodiments, wherein the material has thermal conductivity greater than 100 W/m*K. Embodiment 450 comprises the sensor plate assembly of any one of the embodiments, wherein the material has thermal conductivity greater than 200 W/m*K. Embodiment 451 comprises the sensor plate assembly of any one of the embodiments, wherein the sensor assembly further comprises at least two plate securing elements connected to the ring-shaped element. Embodiment 452 comprises the sensor plate assembly of any one of the embodiments, wherein the plate securing elements connect to an outer perimeter of the ring-shaped element. Embodiment 453 comprises the sensor plate assembly of any one of the embodiments, wherein the plate securing elements extend downward from the ring-shaped element. Embodiment 454 comprises the sensor plate assembly of any one of the embodiments, wherein the plate securing elements extend from the ring-shaped element in opposite direction as the sensor holder. Embodiment 455 comprises the sensor plate assembly of any one of the embodiments, wherein the plate securing elements are connected to the ring-shaped element at about 90 degrees relative to the ring-shaped element. Embodiment 456 comprises the sensor plate assembly of any one of the embodiments, wherein the plate securing elements have a width of at least 1 mm and a length of at least 2 mm. Embodiment 457 comprises the sensor plate assembly of any one of the embodiments, wherein the plate securing elements fit into securing holes in the sensor plate assembly to secure the sensor assembly onto the sensor plate assembly. Embodiment 458 comprises the sensor plate assembly of any one of the embodiments, wherein the plate securing elements are sized to have a smaller width than the securing holes. Embodiment 459 comprises the sensor plate assembly of any one of the embodiments, wherein design of the sensor assembly reduces assembly error in placing the sensor assembly on the sensor plate assembly.

1. A circuit patch for heating a lid of a container comprising at least one of a resistive heating element, an electrically conductive printed contact, or a temperature sensing element, or a combination thereof.

2. The circuit patch of claim 1, wherein the circuit patch is placed on a top portion of the lid.

3. The circuit patch of claim 2, wherein the circuit patch has an adhesive surface that is placed on the top portion of the lid.

4. The circuit patch of claim 1, wherein the circuit patch is directly molded into the lid.

5. The circuit patch of any one of claims 1-4, wherein the resistive heating element is embedded in the circuit patch.

6. The circuit patch of any one of claims 1-5, wherein the resistive heating element is an electrically conductive printed contact.

7. The circuit patch of any one of claims 1-6, wherein the resistive heating element changes the temperature of the lid.

8. The circuit patch of any one of claims 1-7, wherein the resistive heating element has a temperature range from 50° C. to 110° C.

9. The circuit patch of any one of claims 1-8, wherein the circuit patch comprises at least two electrically conductive printed contact.

10. The circuit patch of any one of claims 1-9, wherein the electrically conductive printed contact is placed near the perimeter of the lid.

11. The circuit patch of any one of claims 1-10, wherein the electrically conductive printed contact is placed on top of a hole near the perimeter of the lid.

12. The circuit patch of any one of claims 1-11, wherein the hole is configured to fit an end portion of a spring-loaded contact on a lid heating printed circuit board (PCB) of a container holder when the container is placed in the container holder and the lid closes the open end of the container.

13. The circuit patch of any one of claims 1-12, wherein the spring-loaded contact has a diameter of no more than 0.5 mm.

14. The circuit patch of any one of claims 1-13, wherein the electrically conductive printed contact comes into contact with an end portion of a spring-loaded contact on a container holder when the container is placed in the container holder and the lid closes the open end of the container.

15. The circuit patch of any one of claims 1-14, wherein the electrically conductive printed contact is spaced apart from the resistive heating element.

16. The circuit patch of any one of claims 1-15, wherein the temperature sensing element comprises at least one of a thermistor, a thermocouple, a resistance temperature detector (RTD), or a thermochromic sticker, or a combination thereof.

17. The circuit patch of any one of claims 1-16, wherein the thermistor is a thin film thermistor.

18. The circuit patch of any one of claims 1-17, wherein the temperature sensing element is capable of detecting a temperature range from 50° C. to 110° C.

19. The circuit patch of any one of claims 1-18, wherein the thermochromic sticker is capable of detecting a temperature range from 50° C. to 110° C.

20. The circuit patch of any one of claims 1-19, wherein the thermochromic sticker changes color as a temperature of the circuit patch changes.

21. The circuit patch of any one of claims 1-20, wherein the color change of the thermochromic sticker is captured by a camera.

22. The circuit patch of any one of claims 1-21, wherein the camera comprises a visible light camera.

23. The circuit patch of any one of claims 1-22, wherein the camera comprises an infrared camera.

24. The circuit patch of any one of claims 1-23, wherein a control system uses color change to check temperature of the lid heated by the resistive heating element and makes changes to heating by the resistive heating element as needed.

25. The circuit patch of any one of claims 1-24, wherein a control system uses a reading by the temperature sensing element to control temperature of the resistive heating element.

26. The circuit patch of any one of claims 1-25, wherein a control system uses temperature sensing element to check temperature of the lid heated by the resistive heating element and makes changes to heating by the resistive heating element as needed.

27. The circuit patch of any one of claims 1-26, wherein the control system makes changes to heating by the resistive heating element without user input.

28. The circuit patch of any one of claims 1-27, wherein the temperature sensing element is placed on a top surface of the circuit patch.

29. The circuit patch of any one of claims 1-28, wherein the temperature sensing element is placed on top of the resistive heating element.

30. The circuit patch of any one of claims 1-29, wherein the temperature sensing element is offset from the resistive heating element and near a perimeter of the lid.

31. The circuit patch of any one of claims 1-30, wherein the circuit patch or the container comprises a unique marking.

32. The circuit patch of any one of claims 1-31, wherein the unique marking comprises a QR code.

33. The circuit patch of any one of claims 1-32, wherein the unique marking comprises an RFID identifier.

34. The circuit patch of any one of claims 1-33, wherein the unique marking comprises an identification information.

35. The circuit patch of any one of claims 1-34, wherein the identification information comprises at least one of a sample information, a protocol information, or a temperature protocol information, or a combination thereof.

36. The circuit patch of any one of claims 1-35, wherein the unique marking is readable by a camera.

37. The circuit patch of any one of claims 1-36, wherein the lid comprises a plastic.

38. The circuit patch of any one of claims 1-37, wherein the plastic comprises at least one of polyethylene, polypropylene, or a combination thereof.

39. The circuit patch of any one of claims 1-38, wherein the lid made by injection molding.

40. The circuit patch of any one of claims 1-39, wherein the lid is connected to another lid in a lid strip.

41. The circuit patch of any one of claims 1-40, wherein the lid strip comprises 4, 8, 12, 24, 48, 96, 128, 384, or 1536 lids.

42. The circuit patch of any one of claims 1-41, wherein the heating element of the lid in the lid strip is controlled independently from a heating element of a neighboring lid by a control system.

43. The circuit patch of any one of claims 1-42, wherein the container is connected to another container in a plurality of containers.

44. The circuit patch of any one of claims 1-43, wherein the plurality of containers comprises 4, 8, 12, 24, 48, 96, 128, 384, or 1536 containers.

45. The circuit patch of any one of claims 1-44, wherein the circuit patch is in a layer of a plurality of circuit patches.

46. The circuit patch of any one of claims 1-45, wherein the circuit patch in the plurality of circuit patches is spaced to match the spacing of a plurality of containers.

47. The circuit patch of any one of claims 1-46, wherein the plurality of circuit patches comprises 4, 8, 12, 24, 48, 96, 128, 384, or 1536 circuit patches.

48. The circuit patch of any one of claims 1-47, wherein the layer of the plurality of circuit patches comprises an adhesive layer.

49. The circuit patch of any one of claims 1-48, wherein layer of the plurality of circuit patches comprises an adhesive layer, a sealing layer, and a circuit layer.

50. The circuit patch of any one of claims 1-49, wherein the adhesive layer allows for adhesion the plurality of containers.

51. The circuit patch of any one of claims 1-50, wherein the adhesive layer comprises at least one of a pressure sensitive adhesive or a thermal adhesive.

52. The circuit patch of any one of claims 1-51, wherein the sealing layer provides a barrier to water vapor.

53. The circuit patch of any one of claims 1-52, wherein the sealing layer comprises a heat-resistant polymer.

54. The circuit patch of any one of claims 1-53, wherein the flexible circuit layer comprises an adhesive layer, a heater layer, a substrate layer, and a printed layer.

55. The circuit patch of any one of claims 1-54, wherein the heater layer comprises a resistive heating element, an electrically conductive contact, and a temperature sensor.

56. The circuit patch of any one of claims 1-55, wherein the printed layer comprises a thermochromic ink patch and an identification marking.

57. The circuit patch of any one of claims 1-56, wherein the identification marking comprises a QR code.

58. The circuit patch of any one of claims 1-57, wherein the protruding latch latches onto a container holder to place the electrically conductive in contact with an end portion of a spring-loaded contact on a lid heating printed circuit board (PCB) of the container holder.

59. The circuit patch of any one of claims 1-58, wherein heating of the lid prevents condensation and volume loss of the sample.

60. The circuit patch of any one of the claims, wherein the circuit patch has an opening.

61. The circuit patch of any one of the claims, wherein the circuit patch opening allows for viewing into the container below when the circuit patch is placed over the container.

62. The circuit patch of any one of the claims, wherein the circuit patch opening allows for imaging by the camera of the sample in the container when the circuit patch is placed over the container.

63. The circuit patch of any one of the claims, wherein imaging by the camera of the sample through the circuit patch opening provides information about the sample.

64. The circuit patch of any one of the claims, wherein the sample information is a concentration of a product of a reaction in the container.

65. The circuit patch of any one of the claims, wherein the thermocycler stops the thermocycling protocol for the container when the concentration of the product is above a threshold concentration.

66. The circuit patch of any one of the claims, wherein the sample information is a concentration of a reagent in the container.

67. The circuit patch of any one of the claims, wherein the thermocycler stops the thermocycling protocol for the container when the concentration of the reagent is below a threshold concentration.
